(19) United States
(12) Patent Application Publication
(10) Pub. No.: US 2024/0291587 A1
(43) Pub. Date: Aug. 29, 2024

(54) NETWORK NODE, WIRELESS COMMUNICATION DEVICE, AND METHODS PERFORMED THEREIN

(71) Applicant: Telefonaktiebolaget LM Ericsson (publ), Stockholm (SE)

(72) Inventors: Jonas Fröberg Olsson, Ljungsbro (SE); Yufei Blankenship, Kildeer, IL (US); Niklas Andgart, Södra Sandby (SE)

(21) Appl. No.: 18/570,700

(22) PCT Filed: Jul. 29, 2022
(86) PCT No.: PCT/SE2022/050733

§ 371 Date: Dec. 15, 2023

Related U.S. Application Data
(60) Provisional application No. 63/227,695, filed on Jul. 30, 2021.

(51) Int. Cl. H04L 1/00

(52) U.S. Cl. CPC H04L 1/0026; H04L 1/0003; H04L 1/0016

(57) ABSTRACT

The present disclosure provides a method performed by a wireless communication device. The method comprises: determining at least one range and/or resolution indicator, RRI, for sub-band Channel Quality Indicator, CQI, based on sub-band CQI values for two or more sub-bands; determining sub-band differential CQI values for the sub-band CQI values relative to a wide-band CQI value based on the determined RRI; and transmitting the determined at least one RRI for sub-band CQI and the determined sub-band differential CQI values to a network node.

### TECHNICAL FIELD

The present disclosure generally relates to a network node, a wireless communication device, and methods performed therein for communication in a wireless communication system. In particular, embodiments herein relate to indication of sub-band CQI.

### BACKGROUND

The next generation mobile wireless communication system (5G), or new radio (NR), will support a diverse set of use cases and a diverse set of deployment scenarios. The later includes deployment at both low frequencies (100s of Megahertz (MHZ)), similar to Long Term Evolution (LTE) today, and very high frequencies (millimeter (mm) waves in the tens of Gigahertz (GHz)).

Similar to LTE, NR will use Orthogonal Frequency Division Multiplexing (OFDM) in the downlink (i.e., from a network node, gNB, eNB, or base station, to a user equipment or UE). In the uplink (i.e., from UE to gNB), both OFDM and Discrete Fourier Transform (DFT) spread OFDM (DFT-S-OFDM), also known as Single Carrier Frequency Domain Multiple Access (SC-FDMA) in LTE, will be supported. The basic NR physical resource can thus be seen as a time-frequency grid as illustrated in FIG. 1, where a resource block (RB) in a 14-symbol slot is shown. A resource block corresponds to twelve (12) contiguous subcarriers in the frequency domain. Resource blocks are numbered in the frequency domain, starting with zero (0) from one end of the system bandwidth. Each resource element corresponds to one OFDM subcarrier during one OFDM symbol interval.

Different subcarrier spacing values are supported in NR. The supported subcarrier spacing values (also referred to as different numerologies) are given by Δf=(15×2^{μ}) kHz where μ is a non-negative integer and can be one of {0, 1, 2, 3, 4}. Δf=15 kHz (e.g., μ=0) is the basic (or reference) subcarrier spacing that is also used in LTE. μ is also referred to as the numerology.

In the time domain, downlink and uplink transmissions in NR will be organized into equally-sized subframes of 1 ms each similar to LTE. A subframe is further divided into multiple slots of equal duration. The slot length is dependent on the subcarrier spacing or numerology and is given by

$$\frac{1}{{2}^{μ}} ms .$$

Each slot consists of 14 OFDM symbols for normal Cyclic Prefix (CP).

It is understood that data scheduling in NR can be in slot basis. An example is shown in FIG. 2 with a 14-symbol slot, where the first two symbols contain control channel (i.e., Physical Downlink Control Channel (PDCCH)) and the rest contains data channel (i.e., Physical Downlink Shared Channel (PDSCH)). For convenience, subframe is referred throughout the following sections.

Downlink transmissions can be dynamically scheduled, i.e., in each slot the gNB transmits Downlink Control Information (DCI) about which UE data is to be transmitted to and which resource blocks in the current downlink slot the data is transmitted on. This control signaling is typically transmitted in the first one or two OFDM symbols in each slot in NR. The control information is carried on PDCCH and data is carried on PDSCH. A UE first detects and decodes PDCCH and if a PDCCH is decoded successfully, it then decodes the corresponding PDSCH based on the decoded control information in the PDCCH.

Uplink data transmission can also be dynamically scheduled using PDCCH. Similar to downlink, a UE first decodes uplink grants in PDCCH and then transmits data over the Physical Uplink Shared Channel (PUSCH) based on the decoded control information in the uplink grant such as modulation order, coding rate, uplink resource allocation, and etc.

### Channel State Information (CSI) and CSI Feedback

A core component in LTE and NR is the support of Multiple Input Multiple Output (MIMO) antenna deployments and MIMO related techniques. Spatial multiplexing is one of the MIMO techniques used to achieve high data rates in favorable channel conditions.

For an antenna array with N_{T} antenna ports at the gNB for transmitting r downlink (DL) symbols s=[s₁, s₂, . . . , s_{T}]^{T}, the received signal at a UE with N_{R} receive antennas at a certain Resource Element (RE) n can be expressed as

$${y}_{n} = {H}_{n} Ws + {e}_{n}$$

where yₙ is a N_{R}×1 received signal vector; Hₙ a N_{R}×N_{T} channel matrix at the RE between the gNB and the UE; W is an N_{T}×r precoder matrix; and eₙ is a N_{R}×1 noise plus interference vector received at the RE by the UE. The precoder matrix W can be a wideband precoder, i.e., constant over a whole bandwidth part (BWP), or a subband precoder, i.e. constant over each subband.

The precoder matrix is typically selected from a codebook of possible precoder matrices, and typically indicated by means of a precoder matrix indicator (PMI), which specifies a unique precoder matrix in the codebook for a given number of symbol streams. The r symbols in s each corresponds to a spatial layer, and r is referred to as the transmission rank.

The transmission rank is also dependent on the Signal to Interference plus Noise Ratio (SINR) observed at the UE. Typically, a higher SINR is required for transmissions with higher ranks. For efficient performance, it is important that a transmission rank matches the channel properties as well as the interference observed at a UE. For a given block error rate, the modulation level and coding scheme (MCS) is determined by the SINR, or channel quality. The precoding matrix, the transmission rank, and the channel quality are part of Channel State Information (CSI), which is typically measured by a UE and fed back to a network node or gNB.

Like in LTE, N_{R} has adopted an implicit CSI mechanism where a UE feeds back the downlink CSI as one or more of a transmission rank indicator (RI), a precoder matrix indicator (PMI), and one or two channel quality indicator(s) (CQI). N_{R} supports transmission of either one or two transport blocks (TBs) to a UE in a slot, depending on the rank. One TB is used for ranks 1 to 4, and two TBs are used for ranks 5 to 8. A CQI is associated to each TB. The CQI/RI/PMI report can be either wideband or subband based on configuration.

### Channel State Information Reference Signal (CSI-RS) and CSI-IM

Similar to LTE, CSI-RS was introduced in N_{R} for channel estimations in the downlink. A CSI-RS is transmitted on each transmit antenna port and is used by a UE to measure the downlink channel associated with each of the antenna ports. Up to 32 CSI-RS are defined. The antenna ports are also referred to as CSI-RS ports. The supported number of antenna ports in NR are {1, 2, 4, 8, 12, 16, 24, 32}. By measuring the received CSI-RS, a UE can estimate the channel the CSI-RS is traversing, including the radio propagation channel and antenna gains. CSI-RS for this purpose is also referred to as Non-Zero Power (NZP) CSI-RS.

NZP CSI-RS can be configured to be transmitted in certain REs per PRB. FIG. 3 shows an example of a NZP CSI-RS resource configuration with 4 CSI-RS ports in a Physical Resource Block (PRB) in one slot.

In addition to NZP CSI-RS, Zero Power (ZP) CSI-RS was introduce in N_{R}. The purpose is to indicate to a UE that the associated REs are muted at the gNB. If the ZP CSI-RS is allocated to be fully overlapping with NZP CSI-RS in an adjacent cell, it can be used to improve channel estimation by UEs in the adjacent cell since there is no interference created by this cell.

CSI resource for Interference Measurement (CSI-IM) is used in NR for a UE to measure noise and interference, typically from other cells. CSI-IM comprises of 4 REs in a slot. In NR, two different CSI-IM patterns are possible. Specifically, the CSI-IM pattern can be either 4 consecutive REs in one OFDM symbol or two consecutive REs in both frequency and time domains. An example is shown in FIG. 3. Typically, the gNB does not transmit any signal in the CSI-IM resource so that what is observed in the resource at the UE is noise and interference from other cells.

By measuring both the channel based on a NZP CSI-RS resource and interference based on a CSI-IM resource, a UE can estimate the CSI, i.e. RI, PMI, and CQI(s).

### CSI Framework in NR

In NR, a UE can be configured with one or multiple CSI report configurations. Each CSI report configuration is associated with a bandwidth part (BWP) and contains all the necessary information required for a CSI report, including:
a CSI resource configuration for channel measurement
a CSI-IM resource configuration for interference measurement
reporting type, i.e., aperiodic CSI (on PUSCH), periodic CSI (on PUCCH) or semi-persistent CSI (on PUCCH, and DCI activated on PUSCH).
report quantity specifying what to be reported, such as RI, PMI, CQI
codebook configuration such as type I or type II CSI
frequency domain configuration, i.e., subband vs. wideband CQI or PMI, and subband size
CQI table to be used.

A UE can be configured with one or multiple CSI resource configurations for channel measurement and one or more CSI-IM resources for interference measurement. Each CSI resource configuration for channel measurement can contain one or more NZP CSI-RS resource sets. For each NZP CSI-RS resource set, it can further contain one or more NZP CSI-RS resources. A NZP CSI-RS resource can be periodic, semi-persistent, or aperiodic.

Similarly, each CSI-IM resource configuration for interference measurement can contain one or more CSI-IM resource sets. For each CSI-IM resource set, it can further contain one or more CSI-IM resources. A CSI-IM resource can be periodic, semi-persistent, or aperiodic.

Periodic CSI starts after it has been configured by Radio Resource Control (RRC) and is reported on PUCCH. The associated NZP CSI-RS resource(s) and CSI-IM resource(s) are also periodic.

For semi-persistent CSI, it can be either on PUCCH or PUSCH. Semi-persistent CSI on PUCCH is activated or deactivated by a Medium Access Control (MAC) Control Element (CE) command. Semi-persistent CSI on PUSCH is activated or deactivated by DCI. The associated NZP CSI-RS resource(s) and CSI-IM resource(s) can be either periodic or semi-persistent.

For aperiodic CSI, it is reported on PUSCH and is activated by a CSI request bit field in DCI. The associated NZP CSI-RS resource(s) and CSI-IM resource(s) can be either periodic, semi-persistent, or aperiodic. The linkage between a code point of the CSI request field and a CSI report configuration is via an aperiodic CSI trigger state. A UE is configured by higher layer a list of aperiodic CSI trigger states, where each of the trigger states contains an associated CSI report configuration. The CSI request field is used to indicate one of the aperiodic CSI trigger states and thus, one CSI report configuration.

If there are more than one NZP CSI-RS resource set and/or more than one CSI-IM resource set are associated with a CSI report configuration, only one NZP CSI-RS resource set and one CSI-IM resource set are selected in the aperiodic CSI trigger state. Thus, each aperiodic CSI report is based on a single NZP CSI-RS resource set and a single CSI-IM resource set.

In most of the scenarios, a NZP CSI-RS resource set contains only one NZP CSI-RS resource and a CSI-IM resource set contains a single CSI-IM resource. In some multi-beam scenarios where the gNB has multiple downlink (DL) beams and wants to know the best beam plus the associated CSI for a UE, multiple NZP CSI-RS resources, each associated with a beam, may be configured in a NZP CSI-RS resource set. The UE would select one NZP CSI-RS resource associated with the best beam and report a CSI associated with NZP CSI-RS resource. A CSI-RS Resource Indicator (CRI) would be reported as part of the CSI. In this case, the same number of CSI-IM resources, each paired with a NZP CSI-RS resource need to be configured in the associated CSI-IM resource set. That is, when a UE reports a CRI value k, this corresponds to the (k+1)^{th} entry of the NZP CSI-RS resource set for channel measurement, and, if configured, the (k+1)^{th} entry of the CSI-IM resource set for interference measurement (see, e.g., clause 5.2.1.4.2 of 3GPP TS 38.214 V16.5.0).

FIG. 4 shows an example of aperiodic CSI reporting based on an aperiodic NZP CSI-RS resource for channel measurement and a CSI-IM resource for interference measurement. The CSI is computed based on the aperiodic NZP-CSI-RS and CSI-IM triggered after the DCI. FIG. 5 is an example of aperiodic CSI reporting based on a periodic or semi-persistent NZP CSI-RS resource and a periodic or semi-persistent CSI-IM resource. In this case, the CSI is computed based on the channel and interference measurements done before the DCI triggering the CSI request.

### Channel Quality Indicator (CQI)

In NR, there are three tables ‘table1’, ‘table2’ or ‘table3’ that can define the CQI indices reported by UE. The highest modulation order for ‘table1’ and ‘table3’ is 64QAM, while for ‘table2’ the highest modulation is 256QAM. The 4-bit CQI index for ‘table1’, ‘table2’ and ‘table3’ are specified in Table 5.2.2.1-2 to 5.2.2.1-4 of TS 38.214 v16.5.0, respectively. The CQI derived by the UE shall satisfy the conditions specified in the following excerpt from Section 5.2.2.1, of 3GPP TS 38.214 v16.5.0:

*****Start Excerpt from Section 5.2.2.1 of TS 38.214*****

A single PDSCH transport block with a combination of modulation scheme, target code rate and transport block size corresponding to the CQI index, and occupying a group of downlink physical resource blocks termed the CSI reference resource, could be received with a transport block error probability not exceeding:
0.1, if the higher layer parameter cqi-Table in CSI-ReportConfig configures ‘table1’ (corresponding to Table 5.2.2.1-2), or ‘table2’ (corresponding to Table 5.2.2.1-3), or
0.00001, if the higher layer parameter cqi-Table in CSI-ReportConfig configures ‘table3’ (corresponding to Table 5.2.2.1-4).
   *****End Excerpt from Section 5.2.2.1 of TS 38.214*****
   This means that UE shall report CQI with respect to a target Block-Error Probability (BLEP) of 10% for CQI tables ‘table1’ and ‘table2’ while the target BLEP shall be 0.001% for ‘table3.’

The UE can report wide-band or sub-band CQI where sub-band CQI is reported as a 2-bit sub-band CQI differential as specified in the following excerpt from Section 5.2.2.1 of 3GPP TS 38.214 v16.5.0:

*****Start Excerpt from Section 5.2.2.1 of TS 38.214*****

For each sub-band index s, a 2-bit sub-band differential CQI is defined as:
Sub-band Offset level (s)=sub-band CQI index (s)-wideband CQI index.
   *****End Excerpt from Section 5.2.2.1 of TS 38.214*****

The mapping from the 2-bit sub-band differential CQI values to the offset level is shown in Table 5.2.2.1-1 of TS 38.214.

TS 38.214, Table 5.2.2.1-1: Mapping sub-
band differential CQI value to offset level

| Sub-band differential CQI value | Offset level |
|---|---|
| 0 | 0 |
| 1 | 1 |
| 2 | ≥2 |
| 3 | ≤−1 |

The UE can be configured with one out of two sub-band sizes as specified in the following excerpt from Section 5.2.1.4 of 3GPP TS 38.214 v16.5.0:

*****Start Excerpt from Section 5.2.1.4 of TS 38.214*****

For CSI reporting, a UE can be configured via higher layer signaling with one out of two possible subband sizes, where a subband is defined as N_{PRB}^{SB} contiguous PRBs and depends on the total number of PRBs in the bandwidth part according to Table 5.2.1.4-2.

*****End Excerpt from Section 5.2.1.4 of TS 38.214*****
Table 5.2.1.4-2 of TS 38.214 is reproduced below.

TS 38.214, Table 5.2.1.4-2: Configurable subband sizes

| Bandwidth part (PRBs) | Subband size (PRBs) |
|---|---|
| 24-72 | 4, 8 |
| 73-144 | 8, 16 |
| 145-275 | 16, 32 |

When UE reports CQI, the reported value relates to a transport block on a PDSCH. Hence, the total number of CQI bits further depends on whether the UE reports CQI for one or two transport blocks.

There currently exist certain challenge(s). It is well-known that two PDSCHs with the same rank and MCS (Modulation and Coding Scheme) but different PRB allocation sizes typically will experience different BLEP although the channel quality in all PRBs (Physical Resource Blocks) is the same. This is due to the information theoretical phenomenon that BLEP decreases with increased codeword length although the code rate is kept constant. Therefore, to keep a fixed BLEP, a PDSCH on fewer PRBs requires a better quality than a PDSCH on more PRBs. Hence, a sub-band CQI may hence be lower than the wide-band CQI although there is no difference in quality among the PRBs. This means that UE may have a tendency to report the lowest sub-band offset value “−1” although there is no quality difference between the sub-band and the wide-band CQI. For example, based on channel matrices measured by CSI-RS and CSI-IM, a wide-band CQI is determined as 10, while the sub-band CQIs for sub-bands 1-4 are determined as 4, 8, 11 and 12 respectively. The offset levels would be ≤−1, ≤−1, 1, 2 for each of the sub-bands 1, 2, 3 and 4, respectively. This further means that, since sub-band CQI only can be reported using the thresholds −1, 0, 1 and 2, the gNB cannot know the quality of bad sub-bands other than that they are worse than wide-band quality which clearly limits the gNB ability to select a MCS for PDSCH with a smaller than wide-band allocation size.

Another problem is that CQI may vary quite dramatically even between two consecutive CSI reports due to un-predictable interference. These variations in CQI creates an un-certainty in reported CQI value as a prediction of the quality that a PDSCH will experience. Especially for Ultra-Reliable Low-Latency Communication (URLLC) with high requirements on latency and reliability, it is important to select a MCS that accounts for the un-certainty since otherwise the latency and reliability may not be fulfilled. The un-certainty can be both with respect to time and frequency and the only means available for the gNB to estimate the un-certainty is from CSI reports. From wide-band CQI, the gNB may deduce a standard-deviation (std) measure representing the un-certainty (e.g., std of reported CQI) in channel quality while it will be very hard to determine an accurate sub-band std measure due to the limited range in which sub-band CQI can be reported.

To improve the sub-band CQI resolution, one solution is to define a new sub-band differential table using more bits used to report sub-band CQI, e.g. using 3-bits with thresholds, e.g. −3, −2, −1, 0, 1, 2, 3, 4. This will improve the sub-band CQI resolution but may still be limiting since sub-band CQI may still be outside the range that can be reported.

### SUMMARY

Certain aspects of the present disclosure and their embodiments may provide solutions to the aforementioned or other challenges. Systems and methods are disclosed herein in which a wireless communication device (e.g., a UE) reports a range and/or resolution indicator for sub-band CQI.

There are, proposed herein, various embodiments which address one or more of the issues disclosed herein. In short, it is an object of the present disclosure to provide reporting flexibility and granularity without introducing excessive overhead in CSI reporting. To achieve this object, it is proposed that a Range and Resolution Indicator (RRI) is introduced. The RRI may in some embodiments define an improved sub-band CQI mapping table.

Certain embodiments may provide one or more of the following technical advantage(s). Embodiments disclosed herein may provide improved range and resolution for sub-band CQI, thereby improving gNB knowledge about sub-band CQI. This may then improve the accuracy in MCS selection, which in turn improves spectral efficiency.

According to a first aspect of the present disclosure, a method performed by a wireless communication device (WCD) a provided. The method comprises: determining at least one range and/or resolution indicator, RRI, for sub-band Channel Quality Indicator, CQI, based on sub-band CQI values for two or more sub-bands; determining sub-band differential CQI values for the sub-band CQI values relative to a wide-band CQI value based on the determined RRI; and transmitting the determined at least one RRI for sub-band CQI and the determined sub-band differential CQI values to a network node.

According to a second aspect of the present disclosure, a method performed by a network node is provided. The method comprises: receiving, from a wireless communication device, at least one range and/or resolution indicator, RRI, for sub-band Channel Quality Indicator, CQI, the RRI being based on sub-band CQI values for two or more sub-bands; receiving, from the wireless communication device, sub-band differential CQI values; and determining the sub-band CQI values for the two or more sub-bands for the wireless communication device based on the sub-band differential CQI values and the at least one RRI for sub-band CQI.

In an embodiment, the method performed by the network node may further comprise using the determined sub-band CQI values to perform selection of a modulation and coding scheme, MCS, for a transmission to or from the wireless communication device based on the determined sub-band CQI values.

In an embodiment, the at least one RRI for sub-band CQI may comprise a range and/or resolution indicator that is common to all of the two or more sub-bands.

In an embodiment, the at least one RRI may be a table-indicator that indicates a sub-band differential CQI table, wherein different values of the table-indicator point to different sub-band differential CQI tables.

In an embodiment, at least two of the different sub-band differential CQI tables may map different numbers of sub-band differential CQI values to respective offset levels.

In an embodiment, at least two of the different sub-band differential CQI tables may have different ranges of offset levels.

In an embodiment, the at least one RRI may be a range indicator that indicates an offset relative to offset levels defined in an existing sub-band differential CQI table.

In an embodiment, the range indicator may be common for all of the two or more sub-bands, and the range indicator, R_{offset}, is determined based on a smallest sub-band CQI value, min-SB-CQI, among the sub-band CQI values for the sub-bands such that min-SB-CQI≥WB-CQI−1+R_{offset}, where WB-CQI is the wide-band CQI.

In an embodiment, the at least one RRI may comprise an individual RRI for each of the two or more sub-bands.

In an embodiment, the at least one RRI may comprise an individual range indicator for each of the two or more sub-bands, wherein each range indicator indicates an offset for the respective sub-band relative to offset levels defined in an existing sub-band differential CQI table.

In an embodiment, the at least one RRI may comprise a range and/or resolution indicator that is common to all of the two or more sub-bands and a separate range and/or resolution indicator for at least one of the two or more sub-bands.

In an embodiment, the at least one RRI may be a range indicator that indicates a scaling factor to be applied to offset levels defined in an existing sub-band differential CQI table.

In an embodiment, the at least one RRI may be a range and resolution indicator for sub-band CQI, and the range and resolution indicator for sub-band CQI comprises information that indicates a maximum sub-band CQI value and a minimum sub-band CQI value as the range for the sub-band CQI, and wherein a resolution for sub-band CQI is given by a number of bits used for sub-band differential CQI.

In an embodiment, the at least one RRI may be a range and resolution indicator for sub-band CQI, and the range and resolution indicator for sub-band CQI comprises information that indicates a minimum sub-band CQI value and a resolution for sub-band CQI.

In an embodiment, the at least one RRI may comprise one range and/or resolution indicator per transport block for which the sub-band differential CQI values are reported.

In an embodiment, the at least one RRI may comprise a common range and/or resolution indicator for two or more transport blocks for which the sub-band differential CQI values are reported.

In an embodiment, the at least one RRI may comprise, for each sub-band of the two or more sub-bands, a J+K bit indicator of which J bits provide a parameter that serves as a sub-band range and/or resolution indicator and K bits provide an offset level for the sub-band as a function of the parameter provided by the J bits.

In an embodiment, the parameter may be an offset scale, wherein the offset level scales in proportion with the offset scale. In another embodiment, the parameter may be an offset shift, wherein the offset level is shifted by the offset shift.

In an embodiment, the at least one RRI may comprise separate indicators for two or more groups of sub-bands that are divided from the two or more sub-bands.

According to a third aspect of the present disclosure, a wireless communication device is provided. The wireless communication device is configured to: determine at least one range and/or resolution indicator, RRI, for sub-band Channel Quality Indicator, CQI, based on sub-band CQI values for two or more sub-bands; determine sub-band differential CQI values for the sub-band CQI values relative to a wide-band CQI value based on the determined RRI; and transmit the determined at least one RRI for sub-band CQI and the determined sub-band differential CQI values to a network node.

In an embodiment, the wireless communication device may be configured to perform the method of any one of the above embodiments.

According to a fourth aspect of the present disclosure, a network node is configured. The network node is configured to: receive from a wireless communication device, at least one range and/or resolution indicator, RRI, for sub-band Channel Quality Indicator, CQI, determined based on sub-band CQI values for two or more sub-bands; receive, from the wireless communication device, sub-band differential CQI values; and determine the sub-band CQI values for the two or more sub-bands for the wireless communication device based on the sub-band differential CQI values and the at least one RRI for sub-band CQI.

In an embodiment, the network node may be configured to perform the method of any one of the above embodiments.

### BRIEF DESCRIPTION OF THE DRAWINGS

Embodiments of the invention will be described in more detail hereinafter with reference to examples but to which the scope is not limited.

FIG. 1 illustrates basic NR physical resource.

FIG. 2 illustrates an example with a 14-symbol slot in NR.

FIG. 3 illustrates an example of a NZP CSI-RS resource configuration with 4 CSI-RS ports in a Physical Resource Block (PRB) in one slot.

FIG. 4 illustrates an example of aperiodic CSI reporting based on an aperiodic NZP CSI-RS resource for channel measurement and a CSI-IM resource for interference measurement.

FIG. 5 illustrates an example of aperiodic CSI reporting based on a periodic or semi-persistent NZP CSI-RS resource and a periodic or semi-persistent CSI-IM resource.

FIG. 6 illustrates one example of a cellular communications system 600 in which embodiments of the present disclosure may be implemented.

FIG. 7 illustrates the operation of a WCD 612 and a network node 700 in accordance with one embodiment of the present disclosure.

FIG. 8 illustrates a method of a WCD 612 in accordance with one embodiment of the present disclosure.

FIG. 9 illustrates a method of a network node 700 in accordance with one embodiment of the present disclosure.

FIG. 10 illustrates a schematic block diagram of a network node 700 according to some embodiments of the present disclosure.

FIG. 11 illustrates a schematic block diagram that illustrates a virtualized embodiment of the network node 700 according to some embodiments of the present disclosure.

FIG. 12 illustrates a schematic block diagram of the network node 700 according to some other embodiments of the present disclosure.

FIG. 13 illustrates a schematic block diagram of a WCD 612 (e.g., a UE) according to some embodiments of the present disclosure.

FIG. 14 illustrates a schematic block diagram of the WCD 612 according to some other embodiments of the present disclosure.

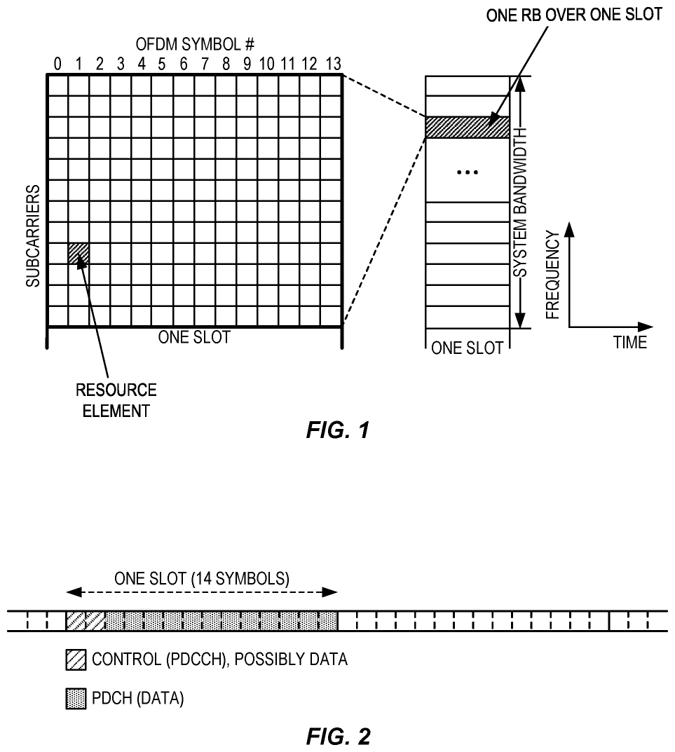

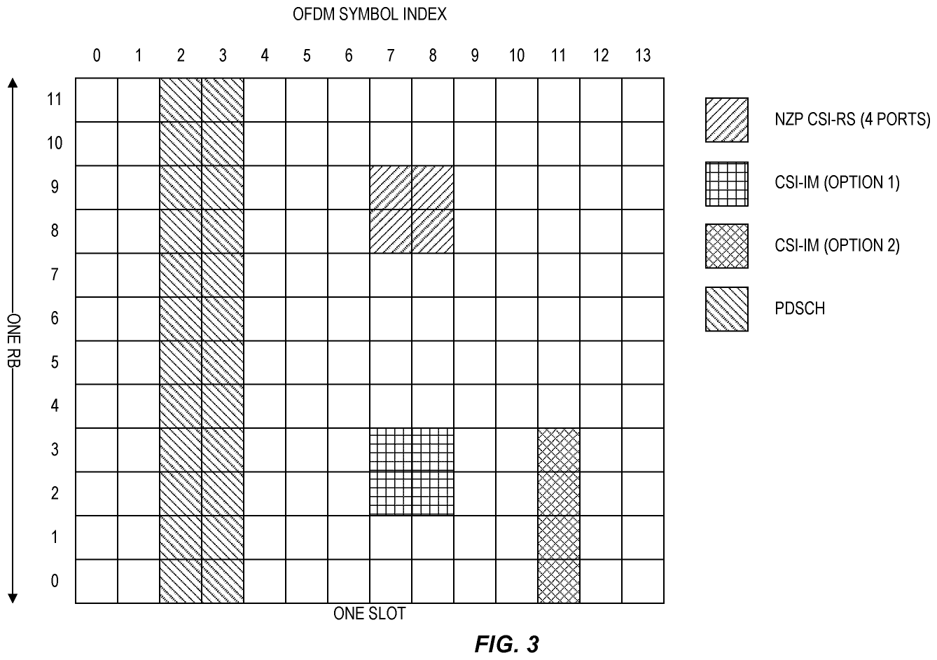

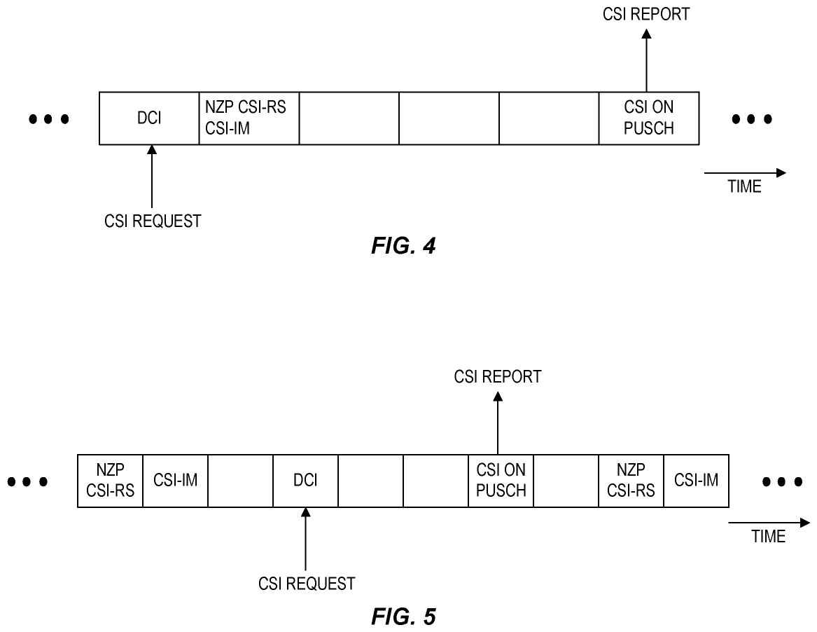

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may also be found in the document(s) provided in the Appendix.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

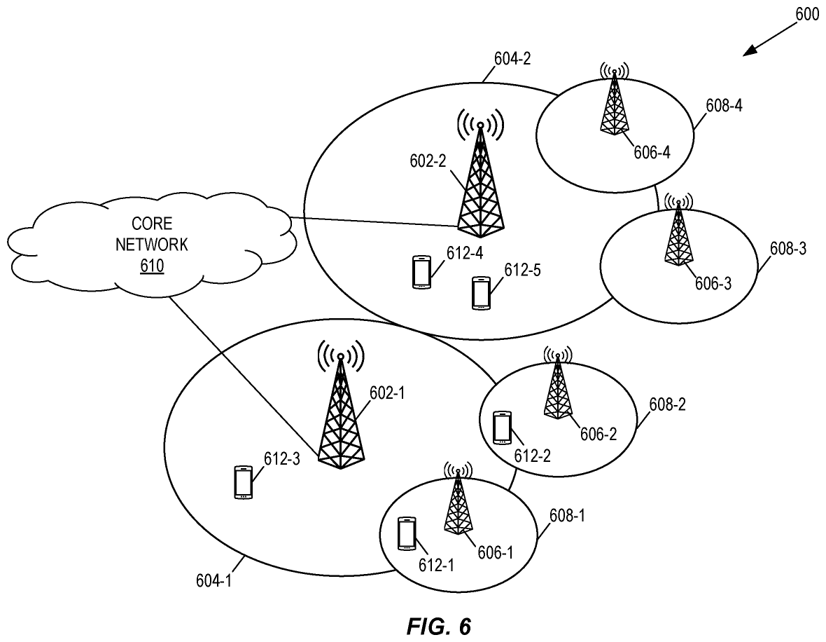

FIG. 6 illustrates one example of a cellular communications system 600 in which embodiments of the present disclosure may be implemented. In the embodiments described herein, the cellular communications system 600 is a 5G system (5GS) including a Next Generation RAN (NG-RAN) and a 5G Core (5GC); however, the present disclosure is not limited to the 5GS. The embodiments described herein may also be used in other types of cellular communications systems or wireless networks in which sub-band CQI is utilized. In this example, the RAN includes base stations 602-1 and 602-2, which in the 5GS include N_{R} base stations (gNBs) and optionally next generation eNBs (ng-eNBs) (e.g., LTE RAN nodes connected to the 5GC), controlling corresponding (macro) cells 604-1 and 604-2. The base stations 602-1 and 602-2 are generally referred to herein collectively as base stations 602 and individually as base station 602. Likewise, the (macro) cells 604-1 and 604-2 are generally referred to herein collectively as (macro) cells 604 and individually as (macro) cell 604. The RAN may also include a number of low power nodes 606-1 through 606-4 controlling corresponding small cells 608-1 through 608-4. The low power nodes 606-1 through 606-4 can be small base stations (such as pico or femto base stations) or RRHs, or the like. Notably, while not illustrated, one or more of the small cells 608-1 through 608-4 may alternatively be provided by the base stations 602. The low power nodes 606-1 through 606-4 are generally referred to herein collectively as low power nodes 606 and individually as low power node 606. Likewise, the small cells 608-1 through 608-4 are generally referred to herein collectively as small cells 608 and individually as small cell 608. The cellular communications system 600 also includes a core network 610, which in the 5GS is 5GC. The base stations 602 (and optionally the low power nodes 606) are connected to the core network 610.

The base stations 602 and the low power nodes 606 provide service to wireless communication devices (WCDs) 612-1 through 612-5 in the corresponding cells 604 and 608. The WCDs 612-1 through 612-5 are generally referred to herein collectively as WCDs 612 and individually as WCD 612. In the following description, the WCDs 612 are oftentimes UEs and as such sometimes referred to herein as UEs 612, but the present disclosure is not limited thereto.

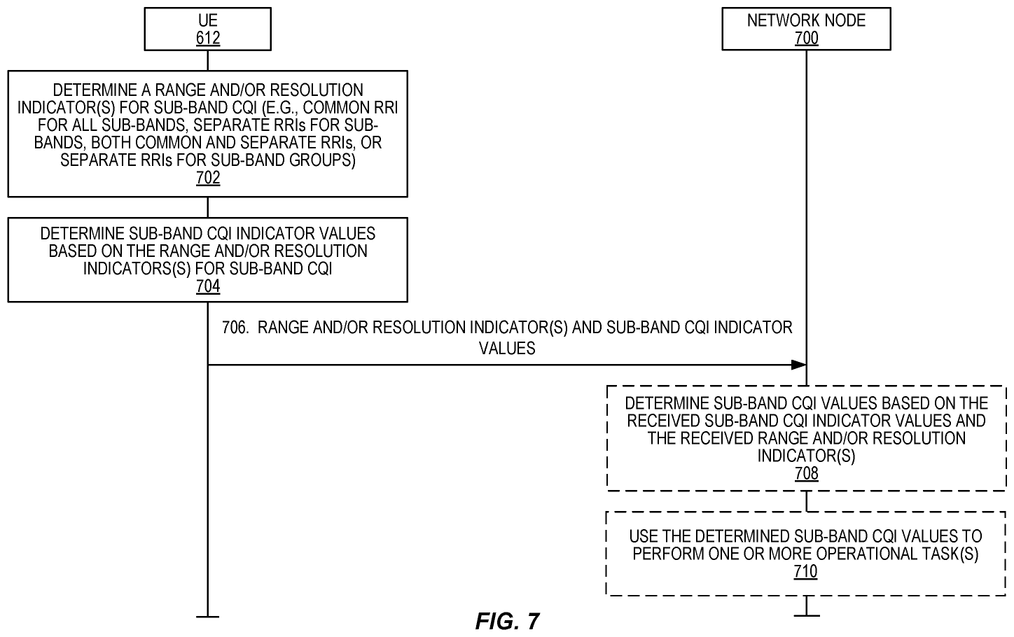

FIG. 7 illustrates the operation of a WCD 612 and a network node 700 in accordance with one embodiment of the present disclosure. The network node 700 may be, e.g., a base station 602 (e.g., a gNB) or a network node that implements part of the functionality of a base station 602 (e.g., a gNB-CU or gNB-DU). Optional steps are represented by dashed lines/boxes. As illustrated, the process of FIG. 7 includes the following steps:
Step 702: The WCD 612 determines an RRI(s) (Range and Resolution Indicator) for sub-band CQI based on sub-band CQI values for two or more sub-bands, e.g., the sub-band CQI index or indices determined by the WCD 612. In some embodiments, a single RRI is determined, where the RRI is common to all subbands. Thus, one RRI is reported by the WCD 612 regardless of the number of subbands. However, as described below, in some other embodiments, the RRI(s) may be determined per sub-band such that the determined RRIs include a separate RRI for each sub-band. In some other embodiments, there may be both a common RRI for all sub-bands and one or more sub-band specific RRIs for one or more specific sub-bands. In some other embodiments, separate RRIs may be determined for two or more sub-band groups.
Step 704: The WCD 612 determines indicators for sub-band CQI (i.e., sub-band differential CQI values for the sub-band CQI values relative to a wide-band CQI value) based on the determined RRI(s). One value is determined and reported for each subband individually. Thus, if there are N subbands, then N sub-band CQI indicators are determined and reported.
Step 706: The WCD 612 transmits the determined RRI(s) and the indicators for sub-band CQI (i.e., the determined sub-band differential CQI values), to the network node 702.
Step 708: The network node 700 determines the sub-band CQI values for the sub-bands for the WCD 612 based on the received sub-band CQI indicator values (i.e., sub-band differential CQI values) and the received RRI(s). In one embodiment, the network node 700 determines sub-band CQI values for the sub-bands for the WCD 612 based on the received sub-band CQI indicator values (i.e., sub-band differential CQI values) and the received RRI(s), together with the reported wideband CQI value. Specifically, in one embodiment, for the k-th subband, the subband CQI value (also called subband CQI index) is determined by: sub-band CQI index (k)=wideband CQI index+Sub-band Offset level (k), where Sub-band Offset level (k) is obtained using the subband CQI indicator (i.e., sub-band differential CQI values) and the received RRI. In other words, the network node 700 interprets the received sub-band CQI indicator values (i.e., sub-band differential CQI values) based on the received RRI(s) in the procedure of determining subband offset level for each subband.
Step 710: The network node 700 uses the determined sub-band CQI values to perform one or more operational tasks (e.g., for MCS selection) for a transmission to or from the wireless communication device (612) based on the determined sub-band CQI values.

The RRI may comprise: (a) a range indicator for sub-band CQI, (b) a resolution indicator for sub-band CQI, or (c) a range and resolution indicator for sub-band CQI. The RRI may be common to two or more sub-bands. The RRI may also comprise an individual or separate RRI for each of the two or more sub-bands. The RRI may indicate the range and/or resolution of the sub-band CQI values. In one embodiment, the range may be the width between a minimum sub-band CQI value and a maximum sub-band CQI value in a sub-band differential CQI table. In one embodiment, the resolution may be adjacent offset level differences in the sub-band differential CQI value table. It may be given by a number of bits used for sub-band differential CQI. It may also be configured as an expression of floor((max-SB-CQI−min-SB-CQI)/N−1), where N is the number of possible sub-band differential CQI values.

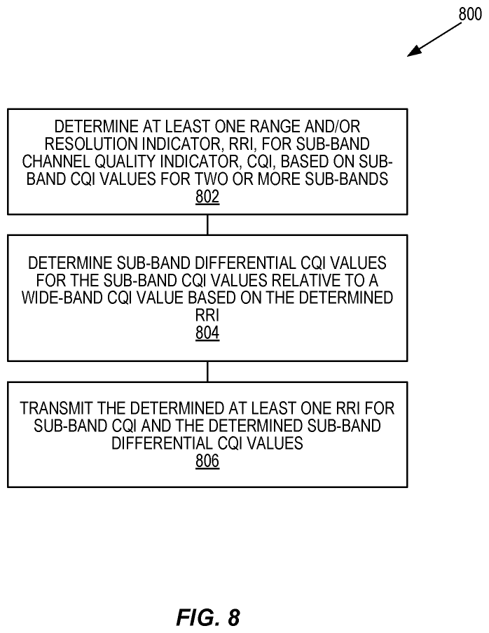

FIG. 8 illustrates a method 800 in accordance with one embodiment of the present disclosure. The method 800 may be performed by a wireless communication device (WCD) 612.

At block 802, the WCD 612 may determine at least one range and/or resolution indicator, RRI, for sub-band Channel Quality Indicator, CQI, based on sub-band CQI values for two or more sub-bands.

At block 804, the WCD 612 may determine sub-band differential CQI values for the sub-band CQI values relative to a wide-band CQI value based on the determined RRI.

At block 806, the WCD 612 may transmit the determined at least one RRI for sub-band CQI and the determined sub-band differential CQI values to a network node.

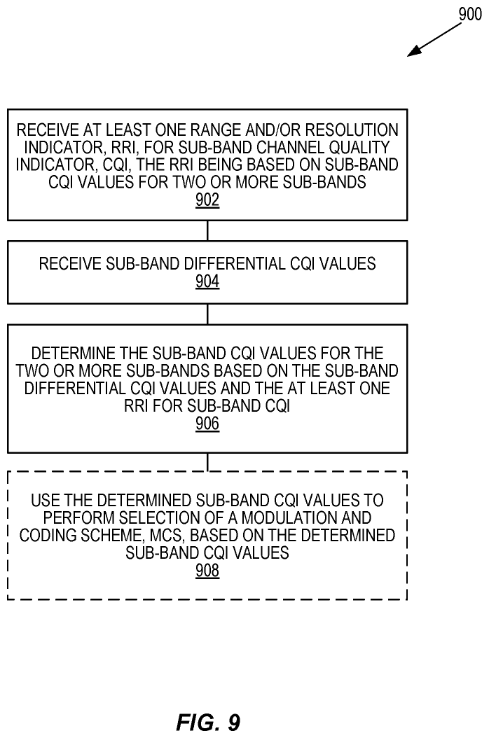

FIG. 9 illustrates a method 900 in accordance with one embodiment of the present disclosure. The method 900 may be performed by a network node 700.

At block 902, the network node 700 may receive, from a wireless communication device (612), at least one range and/or resolution indicator, RRI, for sub-band Channel Quality Indicator, CQI, the RRI being based on sub-band CQI values for two or more sub-bands.

At block 904, the network node 700 may receive, from the wireless communication device (612), sub-band differential CQI values.

At block 906, the network node 700 may determine the sub-band CQI values for the two or more sub-bands for the wireless communication device (612) based on the sub-band differential CQI values and the at least one RRI for sub-band CQI.

Optionally, the method 900 may comprise a block 908, at which the network node 700 may use the determined sub-band CQI values to perform selection of a modulation and coding scheme, MCS, for a transmission to or from the wireless communication device (612) based on the determined sub-band CQI values.

In one embodiment, the RRI (e.g., common RRI for all sub-bands) is a table-indicator indicating a sub-band differential CQI table, with different values of RRI pointing to different subband differential CQI mapping tables. In this example, at least two of the different sub-band differential CQI tables map different numbers of sub-band differential CQI values to respective offset levels, e.g., 4-entry, 8-entry, or 16-entry sub-band differential CQI mapping tables. At least two of the different sub-band differential CQI tables have different ranges of offset levels. For 4-entry and 8-entry sub-band differential CQI mapping tables (Table 1 and 2 below), the ranges are a₁˜a₄ and a₁˜a₈, respectively. In another embodiment, for each of two or more sub-bands, the RRI may comprise an individual or separate range indicator (e.g., table-indicator), wherein each range indicator indicates an offset for the respective sub-band relative to offset levels defined in an existing sub-band differential CQI table. For example, if RRI takes two possible values, RRI=‘0’ may correspond to the existing, 4-entry, mapping table, i.e., Table 5.2.2.1-1 of TS 38.214, while RRI=‘1’ may correspond to a different subband differential CQI mapping table. For instance, RRI=‘1’ points to a new 4-entry subband differential CQI mapping table, e.g., Table 1 below with thresholds a1, a2, a3 and a4. As another example, RRI=‘1’ may point to a new 8-entry subband differential CQI mapping table (e.g., Table 2 below), or a new 16-entry subband differential CQI mapping table. When a RRI value points to a 2^{m}-entry subband differential CQI mapping table, then the bitwidth for reporting a subband differential CQI value is m-bit. For example, if RRI=‘1’ points to a new 8-entry subband differential CQI mapping table (e.g., Table 2 below), then each subband differential CQI value is reported using 3 bits. The table-indicator may indicate a sub-band differential CQI table from among two or more available sub-band differential CQI tables and the different values of the table-indicator may point to different sub-band differential CQI tables from among the two or more available sub-band differential CQI tables.

TABLE 1
Mapping sub-band differential CQI value to 4 offset levels,
with a₁ > a₂ > a₃ > a₄

| Sub-band differential CQI value | Offset level |
|---|---|
| 0 | ≥a₁ |
| 1 | a₂ |
| 2 | a₃ |
| 3 | ≤a₄ |

TABLE 2
Mapping sub-band differential CQI value to 8 offset levels, with a₁ >
a₂ > a₃ > . . . > a₇ > a₈

| Sub-band differential CQI value | Offset level |
|---|---|
| 0 | ≥a₁ |
| 1 | a₂ |
| 2 | a₃ |
| 3 | a₄ |
| 4 | a₅ |
| 5 | a₆ |
| 6 | a₇ |
| 7 | ≤a₈ |

Using the 4-entry table of Table 1 as an example, the values a1-a4 may, in some examples, be fixed by specification (e.g., fixed by 3GPP specification) while in other examples the values are configured by the network, e.g., via RRC signaling, MAC layer signaling, or DCI signaling. In some examples, the WCD 612 may be configured to determine the RRI as a common RRI for all sub-bands based on the smallest sub-band CQI. For example, a4 may be lower than −1 to be able to capture small sub-band CQI differentials wherein WCD 612 would determine RRI=“1” if difference between a sub-band CQI index and the wide-band CQI index is lower than −1. The benefit of signaling a single RRI for all subbands is that the CQI report overhead is small. For example, for reporting a wideband CQI value and B subband differential CQI values (one value for each of the B subbands), the total number of bits of the CQI report is: 4+m_{RRI}+m×B (bits), where 4 (bit) is for wideband CQI, m_{RRI} is the number of bits for reporting the single RRI value, m is the number of bits for reporting one subband differential CQI value. In contrast, if one RRI value is reported for each of the B subbands individually, then the total number of bits of the CQI report is: 4+(m+m_{RRI})×B (bits). On the other hand, the drawback of signaling a single RRI for all subbands is, the mapping table (thus report granularity) of the subband CQI offset levels cannot be adjusted for reach subband.

In another embodiment, the RRI (e.g., common RRI for all sub-bands) is a range indicator (or range offset indicator) indicating a range offset R_{offset} defining a modification of Table 5.2.2.1-1 according to Table 3 below. For example, the range indicator may indicate an offset R_{offset} relative to offset levels defined in an existing sub-band differential CQI table, e.g., Table 5.2.2.1-1 of TS 38.214. In the Table 5.2.2.1-1, the resolution (e.g., adjacent offset level difference) is 1 CQI step for the offset levels −1, 0, 1, 2. In another embodiment, the RRI may comprise an individual (or separate) range indicator for each of two or more sub-bands, wherein each range indicator indicates an offset for the respective sub-band relative to offset levels defined in an existing sub-band differential CQI table. The term “offset level” in the table is also denoted as offset value or offset level value herein.

TABLE 3
Mapping sub-band differential CQI value to offset level

| Sub-band differential CQI value | Offset level |
|---|---|
| 0 | 0 + R_{offset} |
| 1 | 1 + R_{offset} |
| 2 | ≥2 + R_{offset} |
| 3 | ≤−1 + R_{offset} |

In one example, R_{offset} is determined based on smallest sub-band CQI, say min-SB-CQI, such that min-SB-CQI≥WB-CQI−1+R_{offset}, where WB-CQI is the wide-band CQI. If min-SB-CQI is very low compared to WB-CQI there may be no R_{offset} that fulfills the inequality wherein the WCD 612 would select the lowest R_{offset} among the possible values. R_{offset} is thus, in one embodiment, determined such that smallest sub-band CQI shall be within the range that can be indicated by the sub-band differential CQI value. In other examples, R_{offset} is determined based on largest sub-band CQI.

The possible values for R_{offset} may be fixed by standard or possible to configure, e.g., using RRC. For example, with a 1-bit RRI, then one of two values R₁ or R₂ could be selected to use as R_{offset}, where Rᵢ may be fixed, e.g. {R₁=0 and R₂=−5}. Alternatively, the two Rᵢ values could be configured by RRC, e.g. Rᵢ∈{−8, −4, −2, 0, 2} such that the network may configure and signal to the UE that {R₁=−4 and R₂=2}, for example. While semi-statically signaling (i.e., RRC signaling) is a preferred method for configure Rᵢ values, the signaling can be also via MAC signaling or DCI signaling or other type of signaling. In another variation, the set of Rᵢ values depends on one or more other parameters configured, e.g. depending on CQI table, configured sub-band size, number of subbands to report CQI for, BLER target configured for a CQI table, or any combination thereof.

While the discussion above used 1-bit RRI (i.e., m_{RRI}=1) as an example, other integer values of m_{RRI} can be used to provide more flexibility for signalling subband CQI differential index. For example, if 2-bit RRI (i.e., m_{RRI}=2) is used, then the RRI can select one out of four values {R₁, R₂, R₃, R₄} to use as R_{offset}.

While the resolution (e.g., adjacent offset level difference) of 1, and Table 3 specifically, is used as an example, in general, other offset levels can be used in the mapping table, for example, the generic 4-entry Table 4, where the resolution (e.g., adjacent offset level differences) (e.g., a1−a2, a2−a3, etc.) may be larger or smaller than 1, and may not be limited to integer values, e.g., a1−a2=0.5, a1−a2=2, etc. Similarly, a 8-entry mapping table can be constructed using offset levels aj+R_{offset}, j=1, 2, . . . 8. It is noted that the 1-to-1 mapping from “Sub-band differential CQI value” to “offset level” is not critical, and any order of indexing the same set of “offset level” is essentially equivalent, i.e., the key feature is the set of 2^{m} values used as “offset levels”.

TABLE 4
Mapping sub-band differential CQI value to offset level,
with a₁ > a₂ > a₃ > a₄

| Sub-band differential CQI value | Offset level |
|---|---|
| 0 | >=a₁ + R_{offset} |
| 1 | a₂ + R_{offset} |
| 2 | a₃ + R_{offset} |
| 3 | ≤a₄ + R_{offset} |

In other embodiments, a m_{RRI}-bit RRI is indicated per sub-band. For instance, when m_{RRI}=1, the RRIs indicate range offsets R_{offset} (i) E {b₀, b₁} for sub-bands i=0, 1, . . . , where b₀ and b₁ are either predefined values, or configured by the network (e.g., RRC configured). For example, RRI=‘0’ may be configured to mean a range offset b₀=0 while RRI=‘1’ may be configured to mean a range offset b₁=−4. This would effectively yield the offset thresholds −5, −4, −3, −2, −1, 0, 1, 2 when using offset levels shown in Table 3. In some examples of this embodiment, b₁=−4+b₀, where b₀ can be configured by the network (e.g., RRC configured), e.g. b₀ E {0, −1, −2, −3}. In other examples of this embodiment, b₁=−4+b₀, where b₀ depends on other parameters configured, e.g. depending on one or more out of CQI table, configured sub-band size, number of subbands to report CQI for, BLER target configured for a CQI table. For example, if the configured CQI table is ‘table3’, i.e. the WCD 612 is to report CQI with a BLER target 1e-5, then b₀=−1. Another example is that b₀=−1 may hold if the lower sub-band size for a BWP is configured, e.g. if the BWP has 100 PRBs the b₀=−1 holds if the configured sub-band size is 8 PRBs.

In further other embodiments, the last two embodiments are combined. For example, the RRI may include (e.g., consist of) RRI_0 that is common for all sub-bands and RRI_1 (i) that is specific for a sub-band i. The RRI_0 may be selected such that smallest (or largest) sub-band CQI should be possible to be indicated using RRI_1 (i) and the sub-band differential CQI.

In another embodiment, the RRI is a range indicator that indicates a scaling factor F to be applied to offset levels defined in an existing sub-band differential CQI table, e.g., the RRI (e.g., common RRI for all sub-bands) is a range indicator (or range scaling indicator) indicating a scaling factor F such that thresholds a1, a2, a3 and a4 in the sub-band differential CQI table are scaled by the factor F. For example, if RRI=‘0’ then F=1 would be indicated while RRI=‘1’ would indicate F=2. With 0, 1, 2 and −1 as thresholds, then F=2 would give the (scaled) threshold 0, 2, 4, −2. As in previous embodiments, factor F, and hence the RRI to report, may be determined based on smallest (largest) sub-band CQI that the UE obtained from its measurement of DL signal.

In some embodiments, the RRI (e.g., common RRI for all sub-bands) indicates both range and resolution. In such embodiments the RRI is a range and resolution indicator for sub-band CQI, and the range and resolution indicator for sub-band CQI comprises information that indicates a maximum sub-band CQI value and a minimum sub-band CQI value as the range for the sub-band CQI, and a resolution for sub-band CQI is given by a number of bits used for sub-band differential CQI. In one example, RRI could be indicated as the 2-tuple {min-SB-CQI, max-SB-CQI} and wherein the resolution is given by the number of bits for sub-band differential CQI. In one such example, a first offset threshold value a₁ (i.e., the smallest ‘offset level’ value) may be selected as min-SB-CQI−WB-CQI, i.e. the offset threshold value corresponds to the lowest sub-band CQI value, while other offset threshold values would be determined as

$${a}_{i} = ⌊ \frac{max - SB - CQI - min - SB - CQI}{N - 1} ⌋ + {a}_{i - 1} ,$$

where N is the number of possible sub-band differential CQI values. In this case, the resolution would be

$$⌊ \frac{max - SB - CQI - min - SB - CQI}{N - 1} ⌋ .$$

With a 2-bit indicator for sub-band CQI differential then N=4. For example, let WB-CQI=9 and [min-SB-CQI, max-SB-CQI]=[6, 12], then with N=4 we get

$$⌊ \frac{max - SB - CQI - min - SB - CQI}{N - 1} ⌋ = 2$$

as the resolution, which would result in offset threshold values a₁=−3 (6−9), a₂=−1 (−3+2), a₃=1 (−3+2*2) and a₄=3 (−3+2*3). Implicitly based on the RRI={6, 12} (i.e., RRI={min-SB-CQI, max-SB-CQI}) and reported wide-band CQI WB-CQI=9 both WCD and gNB would agree on the sub-band differential CQI value according to Table 4. For reporting 2-tuple {min-SB-CQI, max-SB-CQI} as RRI, each of the values can be represented by m_{RRI} bits, for a total of 2×m_{RRI} bits. For example, both min-SB-CQI and max-SB-CQI are represented by 3 bits, with min-SB-CQI taking 8 values {0, 1, . . . , 7}, and max-SB-CQI taking 8 values {8, 9, . . . , 15}.

TABLE 4
Implicit table for mapping sub-band differential
CQI value to offset level when N = 4 and
WB-CQI = 9 and {min-SB-CQI, max-SB-CQI} = {6, 12}

| Sub-band differential CQI value | Offset level |
|---|---|
| 0 | ≤−3 |
| 1 | −1 |
| 2 | 1 |
| 3 | ≥3 |

Several variants of this embodiment are possible. The RRI is a range and resolution indicator for sub-band CQI, and the range and resolution indicator for sub-band CQI comprises information that indicates a minimum sub-band CQI value and a resolution for sub-band CQI. For example, instead of reporting the RRI as 2-tuple [min-SB-CQI, max-SB-CQI], the WCD 612 may equivalently report RRI as

$$\{ min - SB - CQI , ⌊ \frac{max - SB - CQI - min - SB - CQI}{N - 1} ⌋ \} .$$

In this example, the range and/or resolution indicator for sub-band CQI comprises information that indicates a minimum sub-band CQI value min-SB-CQI and a resolution for sub-band CQI

$$⌊ \frac{max - SB - CQI - min - SB - CQI}{N - 1} ⌋ .$$

In some variants, the WCD 612 may be configured with a “reliability” mode where it is understood that sub-band CQI being lower than the wide-band CQI is of higher importance than sub-band CQI higher than wide-band CQI. In such variants, the offset thresholds values may be determined as a₁=min-SB-CQI and

$${a}_{i} = ⌊ \frac{max - SB - CQI - min - SB - CQI}{N - 1} ⌋ + {a}_{i - 1} .$$

In further other variants

$$⌈ \frac{max - SB - CQI - min - SB - CQI}{N - 1} ⌉$$

is used in the expression for aᵢ. In yet further variants, a first offset threshold value corresponds to highest sub-band CQI value (instead of lowest).

In some embodiments, where the RRI indicates range and/or resolution, the indicated RRI values are not directly taken as, e.g., the min or max of SSB-CQI, but instead the indicated RRI value is based on the WCD's estimation of the most effective way of transmitting the sub-band differential CQI values. For example, if min-SB-CQI=−3 but only at one position, while several values are −2, it may be more beneficial to have an offset level of <=−2, −1, . . . rather than −3, −1, . . . since in the first case the multiple-2 values can be more correctly represented.

In some embodiments, the 2-bit table for sub-band differential CQI value is used to exemplify. The method described herein are easily extended to more bits for sub-band differential CQI value.

In some embodiments, the WCD 612 reports CQI for more than one transport block. In some such embodiments, there is one RRI per transport block for which the sub-band differential CQI values are reported while in other such embodiments there is a RRI that is common for the two or more transport blocks for which the sub-band differential CQI values are reported.

In some embodiments, the WCD 612 reports CQI for more than one transmission-reception point (TRP). For example, the UE may report CQI for two TRPs. In this case, the UE may use a RRI that is common to both TRPs to save reporting overhead. Alternatively, the UE may use two RRI with one RRI for each TRP.

Some embodiments are combined embodiments. For example, the RRI may consist of or comprise a range offset and a range scaling component. In some such embodiments, the range offset (range scaling) component may be common for all sub-bands while there is a range scaling (range offset) component for each sub-band.

In another embodiment, no RRI that governs all sub-bands is reported by the WCD 612. For each sub-band CQI, (J+K) bits are determined (e.g., in step 702) and reported by the WCD 612 (e.g., in step 706). That is, for each sub-band of the two or more sub-bands, the RRI comprises a (J+K) bit indicator of which J bits provide a parameter that serves as a sub-band range and/or resolution indicator and K bits provide an offset level for the sub-band as a function of the parameter provided by the J bits. The portion of J-bit provides a parameter serving as sub-band RRI, and the portion of K-bit uses the parameter to provide the offset level for the given subband. That is, the offset level provided by the K-bit is a function of the parameter provided by the J-bit. For a given subband, its subband-CQI-index is equal to: WB-CQI-index+subband-offset-level, where the subband-offset-level is given by the K-bit.

In one example, the portion of J-bit provides a parameter, where the parameter is an offset scale F. The K-bit uses the offset scale F to indicate the offset level, where the offset level scales in proportion with F. One example is provided in Table 5 below. For instance, using Table 5, if the WCD reports {J-bit=‘1’, K-bit=‘2’} for sub-band bj, then the CQI for sub-band bj is understood as:

$$>= WB - CQI - index + 2 \times F 2 \\ where F = F 2 due to J - bit = ‘ 1 ’ , >= 2 \times F due to K - bit = ‘ 2 ’ .$$

TABLE 5
Mapping sub-band differential CQI value to offset level using (J + K) bit
subband indication. In the example below, J = 1, K = 2

| | Value of J-bit | Offset scale F |
|---|---|---|
| J-bit | 0 | F1 |
| | 1 | F2 |
| | Value of K-bit | Offset level |
| K-bit | 0 | 0 × F |
| | 1 | 1 × F |
| | 2 | ≥2 × F |
| | 3 | ≤−1 × F |

In another example, the portion of J-bit provides a parameter, where the parameter is an offset shift S. The K-bit uses the offset shift S to indicate the offset level, where the offset level is shifted by S. One example is provided in Table 6 below. For instance, using Table 6, if the WCD reports {J-bit=‘1’, K-bit=‘3’} for sub-band bj, then the CQI for sub-band bj is understood as:

$$<= WB - CQI - index + S 2 - 1 \\ where S = S 2 due to J - bit = ‘ 1 ’ , <= S - 1 due to K - bit = ‘ 3 ’ .$$

TABLE 6
Mapping sub-band differential CQI value to offset level using (J + K) bit
subband indication. In the example below, J = 1, K = 2

| | Value of J-bit | Offset shift S |
|---|---|---|
| J-bit | 0 | S1 |
| | 1 | S2 |
| | Value of K-bit | Offset level |
| K-bit | 0 | S + 0 |
| | 1 | S + 1 |
| | 2 | ≥S + 2 |
| | 3 | ≤S − 1 |

In addition to having the RRI indicated for wideband or for individual sub-bands, embodiments above may be combined with a RRI reporting with a different sub-band size. The at least one RRI may comprise separate indicators for two or more groups of sub-bands that are divided from the two or more sub-bands. For example, the number of sub-bands can be divided in two groups with the lower-frequencies sub-bands in one group and the higher frequency sub-bands in another. A larger number of groups (e.g., 4 groups) can also be used.

For each group of sub-bands, an RRI is indicated. This can either be done with a number of identical bits per sub-band, or jointly coded over all groups of sub-bands. An example is given in Table 7 below where the three offset levels −R, 0, and R are used for each sub-band. (The combinations {−R,−R} and {R,R} are here excluded since these could be expressed by a different wideband CQI value, thereby requiring only 3 bit RRI index.)

TABLE 7
Mapping of RRI index to RRI for multiple groups of sub-bands

| | Offset for Sub- | Offset for Sub- |
|---|---|---|
| RRI index | band group 1 | band group 2 |
| 1 | −R | 0 |
| 2 | −R | R |
| 3 | 0 | −R |
| 4 | 0 | 0 |
| 5 | 0 | R |
| 6 | R | −R |
| 7 | R | 0 |

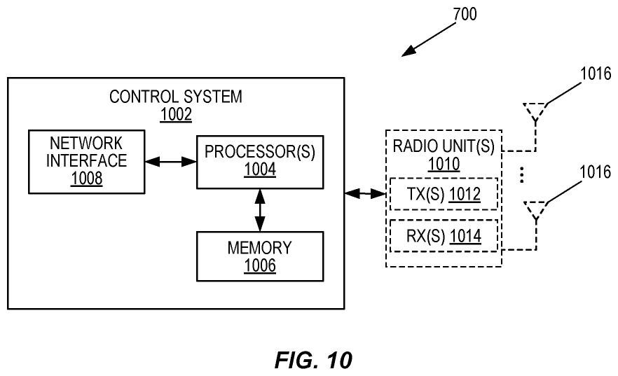

FIG. 10 is a schematic block diagram of a network node 700 according to some embodiments of the present disclosure. Optional features are represented by dashed boxes. The network node 700 may be, for example, a base station 602 or 606 or a network node that implements all or part of the functionality of the base station 602 or gNB described herein. As illustrated, the network node 700 includes a control system 1002 that includes one or more processors 1004 (e.g., Central Processing Units (CPUs), Application Specific Integrated Circuits (ASICs), Field Programmable Gate Arrays (FPGAs), and/or the like), memory 1006, and a network interface 1008. The one or more processors 1004 are also referred to herein as processing circuitry. In addition, if the network node 700 is a radio access node (e.g., a base station 602, gNB, or network node that implements at least some of the functionality of the base station 602 or gNB), the network node 700 may include one or more radio units 1010 that each includes one or more transmitters 1012 and one or more receivers 1014 coupled to one or more antennas 1016. The radio units 1010 may be referred to or be part of radio interface circuitry. In some embodiments, the radio unit(s) 1010 is external to the control system 1002 and connected to the control system 1002 via, e.g., a wired connection (e.g., an optical cable). However, in some other embodiments, the radio unit(s) 1010 and potentially the antenna(s) 1016 are integrated together with the control system 1002. The one or more processors 1004 operate to provide one or more functions of the network node 700 as described herein (e.g., one or more functions of a base station 602, gNB, or network node described herein). In some embodiments, the function(s) are implemented in software that is stored, e.g., in the memory 1006 and executed by the one or more processors 1004.

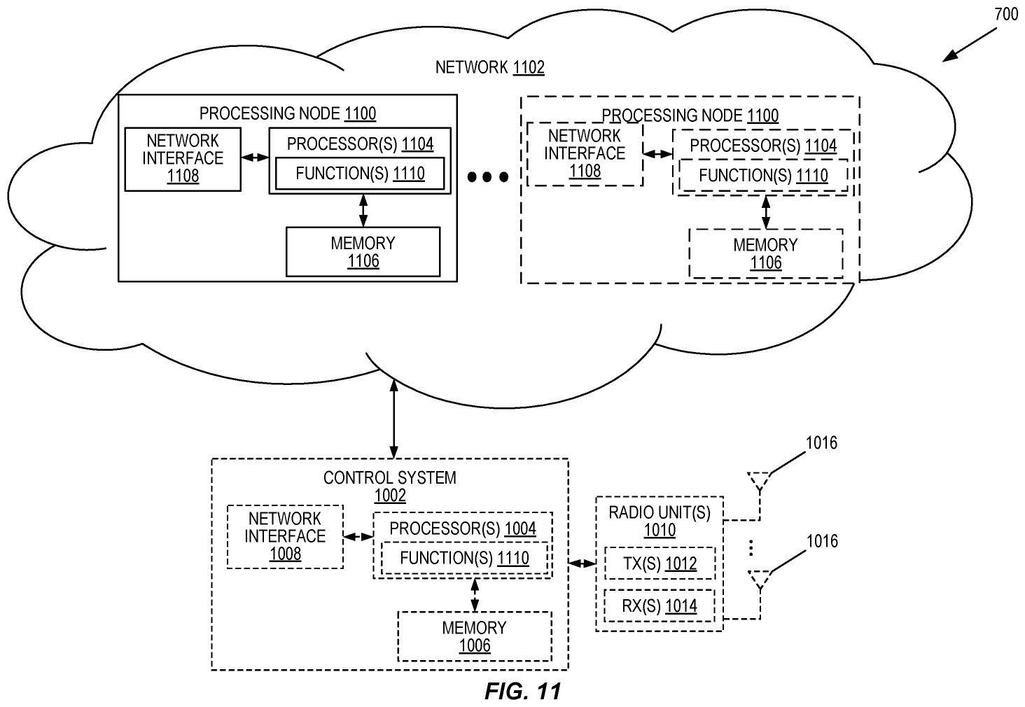

FIG. 11 is a schematic block diagram that illustrates a virtualized embodiment of the network node 700 according to some embodiments of the present disclosure. Again, optional features are represented by dashed boxes. As used herein, a “virtualized” network node is an implementation of the network node 700 in which at least a portion of the functionality of the network node 700 is implemented as a virtual component(s) (e.g., via a virtual machine(s) executing on a physical processing node(s) in a network(s)). As illustrated, in this example, if the network node 700 is a radio access node, the network node 700 may include the control system 1002 and/or the one or more radio units 1010, as described above. The control system 1002 may be connected to the radio unit(s) 1010 via, for example, an optical cable or the like. The network node 700 includes one or more processing nodes 1100 coupled to or included as part of a network(s) 1102. If present, the control system 1002 or the radio unit(s) are connected to the processing node(s) 1100 via the network 1102. Each processing node 1100 includes one or more processors 1104 (e.g., CPUs, ASICS, FPGAs, and/or the like), memory 1106, and a network interface 1108.

In this example, functions 1110 of the network node 700 described herein (e.g., one or more functions of a base station 602, gNB, or network node described herein) are implemented at the one or more processing nodes 1100 or distributed across the one or more processing nodes 1100 and the control system 1002 and/or the radio unit(s) 1010 in any desired manner. In some particular embodiments, some or all of the functions 1110 of the network node 700 described herein are implemented as virtual components executed by one or more virtual machines implemented in a virtual environment(s) hosted by the processing node(s) 1100. As will be appreciated by one of ordinary skill in the art, additional signaling or communication between the processing node(s) 1100 and the control system 1002 is used in order to carry out at least some of the desired functions 1110. Notably, in some embodiments, the control system 1002 may not be included, in which case the radio unit(s) 1010 communicate directly with the processing node(s) 1100 via an appropriate network interface(s). In some embodiments, the method described above may comprise providing user data, and forwarding the user data to a host computer via the transmission to the base station. In some embodiments, the method described above may comprise obtaining user data, and forwarding the user data to a host computer or a wireless communication device.

In some embodiments, a computer program including instructions which, when executed by at least one processor, causes the at least one processor to carry out the functionality of the network node 700 or a node (e.g., a processing node 1100) implementing one or more of the functions 1110 of the network node 700 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

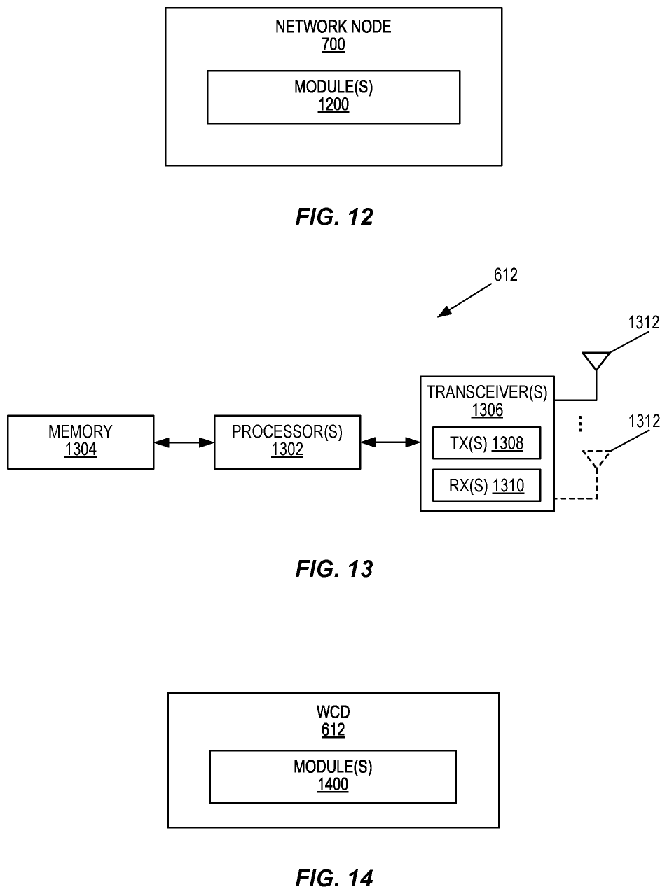

FIG. 12 is a schematic block diagram of the network node 700 according to some other embodiments of the present disclosure. The network node 700 may comprise processing circuitry configured to: receive from a wireless communication device (612), at least one range and/or resolution indicator, RRI, for sub-band Channel Quality Indicator, CQI, determined based on sub-band CQI values for two or more sub-bands; receive, from the wireless communication device (612), sub-band differential CQI values; and determine the sub-band CQI values for the two or more sub-bands for the wireless communication device (612) based on the sub-band differential CQI values and the at least one RRI for sub-band CQI. The processing circuitry is further configured to perform the method of any one of the embodiments mentioned above. The network node 700 includes one or more modules 1200, each of which is implemented in software. The module(s) 1200 provide the functionality of the network node 700 described herein. For example, the module 1200 may be a processing circuitry providing the above functionality of the network node 700. This discussion is equally applicable to the processing node 1100 of FIG. 9 where the modules 1200 may be implemented at one of the processing nodes 1100 or distributed across multiple processing nodes 1100 and/or distributed across the processing node(s) 1100 and the control system 1002.

FIG. 13 is a schematic block diagram of a WCD 612 (e.g., a UE) according to some embodiments of the present disclosure. As illustrated, the WCD 612 includes one or more processors 1302 (e.g., CPUs, ASICs, FPGAs, and/or the like), memory 1304, and one or more transceivers 1306 each including one or more transmitters 1308 and one or more receivers 1310 coupled to one or more antennas 1312. The transceiver(s) 1306 includes radio-front end circuitry connected to the antenna(s) 1312 that is configured to condition signals communicated between the antenna(s) 1312 and the processor(s) 1302, as will be appreciated by on of ordinary skill in the art. The processors 1302 are also referred to herein as processing circuitry. The transceivers 1306 are also referred to herein as radio circuitry. In some embodiments, the functionality of the WCD 612 (or UE) described above may be fully or partially implemented in software that is, e.g., stored in the memory 1304 and executed by the processor(s) 1302. Note that the WCD 612 may include additional components not illustrated in FIG. 13 such as, e.g., one or more user interface components (e.g., an input/output interface including a display, buttons, a touch screen, a microphone, a speaker(s), and/or the like and/or any other components for allowing input of information into the WCD 612 and/or allowing output of information from the WCD 612), a power supply (e.g., a battery and associated power circuitry), etc.

In some embodiments, a computer program including instructions which, when executed by at least one processor, causes the at least one processor to carry out the functionality of the WCD 612 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 14 is a schematic block diagram of the WCD 612 according to some other embodiments of the present disclosure. The WCD 612 may comprise processing circuitry configured to: determine at least one range and/or resolution indicator, RRI, for sub-band Channel Quality Indicator, CQI, based on sub-band CQI values for two or more sub-bands; determine sub-band differential CQI values for the sub-band CQI values relative to a wide-band CQI value based on the determined RRI; and transmit the determined at least one RRI for sub-band CQI and the determined sub-band differential CQI values to a network node. The processing circuitry is further configured to perform the method of any one of the embodiments mentioned above. The WCD 612 includes one or more modules 1400, each of which is implemented in software. The module(s) 1400 provide the functionality of the WCD 612 (or UE) described herein. For example, the module 1400 may be a processing circuitry providing the above functionality of the WCD 612.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### APPENDIX

3GPP TSG RAN WG1 #106-e Tdoc R1-21xxxx
e-Meeting, Aug. 16-27, 2021
Agenda Item: 8.3.1.2
Source: Ericsson
Title: CSI Feedback Enhancements for IIoT/URLLC
Document for: Discussion

### 1 Introduction

Rel-17 IIOT/URLLC working has been approved and scope was revised recently [1]. Among other objectives, the first objective says:
1. Study, identify and specify if needed, required Physical Layer feedback enhancements for meeting URLLC requirements covering:
   a. UE feedback enhancements for HARQ-ACK [RAN1]
   b. CSI feedback enhancements to allow for more accurate MCS selection [RAN1]
   Note: DMRS-based CSI feedback is not in scope of this WI

In RAN #92e, the following recommendation was concluded:
Revised Recommendation1: Provide the following RAN guidance on CSI feedback enhancement [RAN1]
   Focus subsequent working group discussions on the schemes proposed in RP-211297.

That is, the CSI discussion should focus on the following two schemes as proposed in RP-211297:

Proposal: RAN confirms the following as a guidance to RAN1 for CSI enhancement in Enhanced
URLLC/IIoT WI:
RAN1 to further investigate the following for CSI enhancements for IIoT/URLLC:

| - | Increasing the number of bits used for the reported subband CQI (3-bits differential | |
|---|---|---|
| | subband CQI or 4-bits CQI) | |
| - | Reporting of delta-MCS: | |
| | ∘ | Report consists of delta-MCS for a TB received with MCS index I_{MCS}: |

| | |
|---|---|
| ▪ | delta-MCS is calculated from the difference between I_{MCS}_{_{—}}_{tgt} and I_{MCS}, |
| | where I_{MCS}_{_{—}}_{tgt} is the largest MCS index such that the estimated BLER for a |
| | TB received with this MCS index would be smaller than or equal to a |
| | BLER target, and I_{MCS} is the MCS index of the received TB. |

In this paper we present our view on the CSI feedback enhancements listed for further study.

### 2 Discussion

### 2.1 Improve the Granularity of Sub-Band CQI

This method proposes to improve the granularity of sub-band CQI reported by the UE, so as to improve the MCS selection by gNB for subsequent PDSCH scheduling. Instead of 2-bit sub-band CQI, more bits (e.g., 3-bit or 4-bit) are used to reduce the sub-band CQI quantization error, together with an improved sub-band differential CQI mapping table.

To provide reporting flexibility and granularity without excessive overhead in CSI report, it is proposed that a Range and Resolution Indicator (RRI) is introduced to define the improved sub-band CQI mapping table.

### Proposal 1 Introduce a Range and Resolution Indicator (RRI) to Define the Improved Sub-Band CQI Mapping Table.

2.1.1 Alternative 1. One Range and Resolution Indicator (RRI) for all Subband

The straightforward way is to increase sub-band CQI from 2-bit to 3-bit (for example) for each sub-band. In this case, the total number of bits for CQI report is: 4+3×N_{SB}. Here N_{SB} is the number of sub-bands.

In contrast, if a Range and Resolution Indicator (RRI) common to all subband is reported, then the total number of bits for CQI report is: 4+m_{RRI}+m×B (bits), see Table 8 below.

TABLE 8
Fields for improved sub-band CQI reporting (Alternative 1)

| Number of instances | | |
|---|---|---|
| in CSI report | Field | Bitwidth |
| One wideband CQI for | Wide-band CQI 4 | 4 |
| the first TB | | |
| One RRI for the first TB | Range and Resolution | m_{RRI} |
| | Indicator (RRI) | |
| N_{SB} Sub-band differential | Sub-band differential CQI | 2 |
| CQI for the first TB | | |

| | |
|---|---|
| Total number of bits for CQI | 4 + m_{RRI} + |
| | 2 × N_{SB} |

If the RRI is used to indicate a value R_{offset} out of 2^{m}^{_{RRI}} possible values, then the mapping table for sub-band differential CQI can be formulated as in Table 9.

TABLE 9
Mapping sub-band differential CQI value
to offset level (Alternative 1)

| Sub-band differential CQI value | Offset level |
|---|---|
| 0 | 0 + R_{offset} |
| 1 | 1 + R_{offset} |
| 2 | ≥2 + R_{offset} |
| 3 | ≤−1 + R_{offset} |

### 2.1.2 Alternative 2. One Range and Resolution Indicator (RRI) for Each Subband

While the reporting overhead is low if one RRI is reported to cover all subbands (Alternative 1), the accuracy and flexibility of subband CQI indication are compromised.

In Alternative 2, one RRI is reported for reach subband individually. For example, if a 1-bit RRI is reported for each subband, then the total number of bits for CQI report is: 4+3×N_{SB} (bits), see Table 10 below.

TABLE 10
Fields for improved sub-band CQI reporting (Alternative 2)

| Number of instances in CSI | | |
|---|---|---|
| report | Field | Bitwidth |
| One wideband CQI for | Wide-band CQI 4 | 4 |
| the first TB | | |
| N_{SB} RRI for the first TB | Range and Resolution | 1 |
| | Indicator (RRI) | |
| N_{SB} Sub-band differential | Sub-band differential CQI | 2 |
| CQI for the first TB | | |

| | |
|---|---|
| Total number of bits for CQI | 4 + 3 × |
| | N_{SB} |

If the RRI is used to indicate a value S out of two possible values (S₁, S₂), then the mapping table for sub-band differential CQI can be formulated as in Table 11.

TABLE 11
Mapping sub-band differential CQI value to offset
level for each sub-band (Alternative 2)

| | RRI Value | Offset shift S |
|---|---|---|
| 1-bit Range and Resolution | 0 | S₁ |
| Indicator (RRI) | 1 | S₂ |
| | Sub-band | |
| | differential | |
| | CQI value | Offset level |
| Sub-band differential | 0 | S + 0 |
| CQI for the first TB | 1 | S + 1 |
| | 2 | ≥S + 2 |
| | 3 | ≤S − 1 |

### 2.2 Delta-MCS Report

According to guidance from RAN #92e, RAN1 should continue the investigation of delta-MCS reporting for enhanced CSI.

The amount of additional information transmitted from the UE to the gNB will increase with the addition of delta-MCS/CQI. This information can either be transmitted bundled into an updated HARQ-ACK codebook, or stand-alone, outside the HARQ-ACK codebook as a form of A-CSI.

2.2.1 Alternative 1: Delta-MCS is Reported Together with HARQ-ACK Codebook

### 2.2.1.1 Timing for Report Delta-MCS

If delta-MCS is to be reported together with HARQ-ACK codebook, the timing indication can reuse the existing DCI field, “PDSCH-to-HARQ_feedback timing indicator”.

In order to generate delta-MCS report in addition to the HARQ-ACK, the UE needs to perform additional processing on the PDSCH, in addition to the existing channel estimation, LDPC decoding, etc. However, we expect the added operations to be limited in comparison to what already is done in the decoding process, and the minimum HARQ-ACK feedback timing T_{proc,1} does not need to change.

On the other hand, lower-capability UE may explicit demand extra PDSCH processing time. If this is considered necessary, then T_{proc,1} can be extended by adding an extra delay d₃, as shown below.

$${T}_{proc , 1} = ( {N}_{1} + {d}_{1 , 1} + {d}_{2} + {d}_{3} ) ( 2048 + 1 \; 44 ) \cdot {κ2}^{- μ} \cdot {T}_{C} + {T}_{ext}$$

T_{proc,1} is calculated with extra delay d₃ whenever the delta-MCS is needed for the corresponding PDSCH. The value of delay d₃ can vary with UE capability.

### 2.2.1.2 What HARQ-ACK CB to Report Delta-MCS With?

Among the three types of HARQ-ACK codebook, it is not necessary to support delta-MCS with all of the types. For Type-3 HARQ-ACK codebook (one-shot feedback), it does not make sense to expand with delta-MCS. This is because Type-3 codebook is intended to synchronize HARQ status between gNB and UE, and is used sparingly. It cycles through all of the following: serving cell index; HARQ process number; TB index; CBG index. Thus Type-3 HARQ-ACK codebook already has unnecessarily high overhead on the UCI especially if the HARQ based on code block group is activated. There is no motivation to add delta-MCS report to Type-3 HARQ-ACK CB.

### Proposal 2 do not Support Adding Delta-MCS Report to Type-3 HARQ-ACK Codebook.

Thus we consider only Type-1 and Type-2 HARQ-ACK codebook for incorporating delta-MCS in the report. Mechanisms should be in place to ensure no (or negligible) confusion about HARQ-ACK codebook size, and for which PDSCH each feedback bit(s) is provided.

For Type-1 HARQ-ACK CB, the semi-static codebook design uses fixed codebook size and fixed HARQ-ACK bit indexing to avoid confusion of codebook size and HARQ-ACK bit interpretation. To ensure the same robustness against error, the Type-1 HARQ-ACK CB can be extended by making each HARQ-ACK entry from 1-bit to 2-bit. This is called the multi-bit HARQ-ACK method in the discussion below. This straight-forward way to add the extra information to the Type-1 codebook may result in doubling (or more) of the codebook size.

To limit the number of transmitted bits, the delta-MCS can be specified to only be transmitted if certain conditions occur. Here, however, care must be taken to avoid potential error cases, for example, error handling if the UE miss the first scheduling DCI. The error cases may cause: (a) error in the number of delta-MCS bits; or (b) error in understanding which PDSCH each delta-MCS bit is for. To maintain the integrity of HARQ-ACK CB, the Type-1 HARQ-ACK CB can be kept as is, while appending the set of delta-MCS bits to the end of Type-1 codebook. This ensures that there is no misunderstanding of HARQ-ACK as long as the total number of bits appended for delta-MCS is correct, even if there is misunderstanding of delta-MCS bit individually. This method essentially treats delta-MCS as a separate UCI than HARQ-ACK. This is called the delta-MCS UCI method in the discussion below.

The considerations above apply to Type-2 HARQ-ACK CB as well. For Type-2 CB, it may be acceptable to double the codebook size since Type-2 CB construction is efficient with size. To achieve the benefit of delta-MCS reporting for high-priority, low-latency traffic without excessive reporting overhead, a reasonable compromise is to only report Type-2 HARQ-ACK CB of high PHY priority, where each HARQ-ACK bit is expanded into the multi-bit HARQ-ACK (e.g., 2-bit HARQ-ACK), i.e., the multi-bit HARQ-ACK method. The delta-MCS UCI method can be applied to Type-1 CB as well.

Proposal 3 Adopt Either Multi-Bit HARQ-ACK Method or Delta-MCS UCI Method to Report Delta-MCS Together with the HARQ-ACK Codebook (Type-1 or Type-2).

### 2.2.1.3 What PDSCHs to Provide Delta-MCS For?

Another consideration is, what PDSCHs to provide delta-MCS for? The downlink data can be transmitted in various manners, including:
(a) PDSCHs on a single carrier, or multiple DL carriers;
(b) TDD or FDD;
(c) Dynamically scheduled PDSCH, or SPS PDSCH;
(d) PDSCH with, or without repetition;
(e) PDSCH carrying TB configured with CBG based HARQ-ACK;
(f) A PDSCH with a single codeword (i.e., TB), or two codewords (i.e., TBs);
(g) PDSCH for initial transmission of a TB, or retransmission of a TB;
(h) PDSCHs over two TRPs;

Decisions need to be made on if, and how, to provide delta-MCS for each scenarios above.

For (a)-(e), no restriction should be imposed for reporting delta-MCS. For example, for (b), delta-MCS is supported for both TDD and FDD. For (f), if CBG-based HARQ-ACK is configured, multiple ACK/NACK bits are provided for a TB (one bit per CBG), and one delta-MCS feedback is provided for the entire TB (i.e., not for each CBG individually).

For (f), it is not expected that URLLC/IIOT traffic uses 5-8 MIMO layers. Thus, restriction can be imposed that delta-MCS is supported for single codeword case only.

For (g), it should be considered whether a delta-MCS should be transmitted only for first transmissions, or also for retransmissions. Here, it can be expected that only a minor portion of the transmissions generate a retransmission, so the added cost for including retransmissions will be minor. In addition, this makes the standardization simpler and resolves ambiguity in cases where the UE misses the first DCI (i.e., retransmission scheduled by gNB is interpreted as initial transmission by UE). The transmitted information related to a retransmission may also help the gNB to schedule properly to fulfil a latency bound. A possible alternative is to only let delta-MCS be transmitted when scheduled with a SPS-PDSCH, since an SPS PDSCH is always the initial transmission, without any ambiguities.

For (h), issues related to multi-TRP PDSCH can be delayed to Rel-18.
Proposal 4 . . .
Observation 1 . . .

### 2.2.1.4 Mapping Table for Delta-MCS

### Mapping Table for Multi-Bit HARQ-ACK Method

An example of a table added to HARQ-ACK codebook is given below in Table 12. Typical values could be d₀=d₁=−1, d₂=0, d₃=1, but also non-integer values could be used, letting the gNB accumulate or average over multiple reports.

TABLE 12
Mapping table for 2-bit HARQ-ACK feedback
that provides CSI in addition to ACK/NACK

| 2-bit | Information provided | | |
|---|---|---|---|
| HARQ-ACK | Feedback on | Feedback on | |
| feedback | data packet | CQI/MCS | |
| value | reception | (delta_MCS) | Explanation |
| 00 | NACK | d₀ | NACK: The data packet(s) was not successfully |
| | | | received, lower MCS recommended; d₀ < 0 |
| 01 | ACK | d₁ | ACK: The data packet(s) was successfully |
| | | | received, but lower MCS recommended; d₁ < 0 |
| 10 | ACK | d₂ | ACK: The data packet(s) was successfully |
| | | | received, acceptable MCS; d₂ = 0 typically |
| 11 | ACK | d₃ | ACK: The data packet(s) was successfully |
| | | | received, a higher MCS can be tolerated; d3 > 0 |

### Mapping Table for Multi-Bit HARQ-ACK Method

TABLE 13
Mapping table for 1-bit delta-MCS
feedback separately from ACK/NACK

| Feedback on CQI/MCS (delta_MCS) | Explanation |
|---|---|
| 0 | Recommend to reuse the |
| | same MCS which was used |
| | for scheduling the |
| | current PDSCH |
| 1 | Recommend to use lower |
| | MCS than the MCS used |
| | for scheduling the |
| | current PDSCH |

2.2.2 Alternative 2: Delta-MCS is Reported Separately from HARQ-ACK

An alternative solution is to transmit the delta-MCS bits outside the HARQ-ACK codebook. In that case, it should be transmitted on PUCCH rather than on PUSCH, due to the limited amount of added information. Thus, it will be transmitted as a form of A-CSI on PUCCH.

Proposal 5 if Delta-MCS should be Transmitted Outside the HARQ-ACK Codebook, it should be Transmitted on PUCCH Rather than on PUSCH.

With the delta-MCS transmitted on PUCCH, the UE can be configured with parameters related to when and how often to report, which PUCCH resource, and what BLER target to aim at.

When transmitting separately from HARQ-ACK feedback, without the mapping between a PDSCH transmission and the resulting HARQ-ACK, a reference PDSCH needs to be defined for the delta-MCS report to be compared to.

### Observation 2 Transmission of Delta-MCS on as A-CSI on PUCCH May Occupy Less Resources.

Table 14 below shows an example for a 2-bit delta-MCS table, transmitted separately from the HARQ-ACK feedback. Compared to Table 12 above, this table does not need to provide space for the ACK/NACK feedback, and uses two different levels of suggested MCS decrease, a level that is generated based on the estimated BLEP in relation to the configured target BLER.

TABLE 14
Mapping table for delta-MCS feedback
separate from HARQ-ACK report

| | Information | |
|---|---|---|
| 2-bit | provided | |
| delta-MCS | Feedback | |
| feedback | on CQI/MCS | |
| value | (delta_MCS) | Explanation |
| 00 | d₀ | Estimated BEP significantly too |
| | | high. Lower MCS recommended; |
| | | d₀ < 0 |
| 01 | d₁ | Estimated BEP slightly too high. |
| | | Slightly lower MCS recommended; |
| | | d₁ < 0 |
| 10 | d₂ | Acceptable MCS; d₂ = 0 |
| 11 | d₃ | A higher MCS can be tolerated; d3 > 0 |

### 3 Conclusion

Based on the discussions above, the following observations were made:
Observation 1 [symbol]
Observation 2 Transmission of delta-MCS on as A-CSI on PUCCH may occupy less resources.
   Furthermore, the following proposals were made:
Proposal 1 Introduce a Range and Resolution Indicator (RRI) to define the improved sub-band CQI mapping table.
Proposal 2 Do not support adding delta-MCS report to Type-3 HARQ-ACK codebook. Proposal 3 Adopt either multi-bit HARQ-ACK method or delta-MCS UCI method to report delta-MCS together with the HARQ-ACK codebook (Type-1 or Type-2).
Proposal 4 [symbol]
Proposal 5 If delta-MCS should be transmitted outside the HARQ-ACK codebook, it should be transmitted on PUCCH rather than on PUSCH.

### 4 References

[1] RP-201310 Revised WID: Enhanced Industrial Internet of Things (IoT) and ultra-reliable and low latency communication (URLLC) support for N_{R}, Nokia, June 2020.

Further method examples, wireless communication device examples, network node examples and communication system examples are:

### Group A Examples

1. A method performed by a wireless communication device (612), the method comprising:
determining (702) a range and/or resolution indicator(s) for sub-band Channel Quality Indicator, CQI, based on sub-band CQI values for two or more sub-bands, the range and/or resolution indicator(s) comprising: (a) a range indicator for sub-band CQI, (b) a resolution indicator for sub-band CQI, or (c) a range and resolution indicator for sub-band CQI;
determining (704) sub-band CQI indicator values for the sub-band CQI values based on the range and/or resolution indicator(s); and
transmitting (706) the range and/or resolution indicator(s) for sub-band CQI and the sub-band CQI indicator values to a network node.

2. The method of example 1 wherein the range and/or resolution indicator(s) for sub-band CQI consist of a range and/or resolution indicator that is common to all of two or more sub-bands.

3. The method of example 1 or 2 wherein range and/or resolution indicator(s) is a table-indicator(s) that indicates a sub-band differential CQI table, wherein different values of the table-indicator(s) point to different sub-band differential CQI tables.

4. The method of example 1 or 2 wherein range and/or resolution indicator(s) is a table-indicator(s) that indicates a sub-band differential CQI table from among two or more available sub-band differential CQI tables, wherein different values of the table-indicator(s) point to different sub-band differential CQI tables from among the two or more available sub-band differential CQI tables.

5. The method of example 3 or 4 wherein at least two of the different sub-band differential CQI tables are of different sizes (i.e., map different numbers of sub-band differential CQI values to respective offset values).

6. The method of any of examples 3 to 5 wherein at least two of the different sub-band differential CQI tables have different ranges of offset values.

7. The method of example 1 or 2 wherein range and/or resolution indicator(s) is a range offset indicator(s) that indicates a range offset relative to offset level values defined in an existing sub-band differential CQI table.

8. The method of example 7 wherein the range offset indicator(s) is a range offset indicator that is common for all of the two or more sub-bands, and the range offset indicator, Roff set, is determined based on a smallest sub-band CQI value, min-SB-CQI, among the sub-band CQI values for the sub-bands such that min-SB-CQI≥ WB-CQI−1+R_{offset}, where WB-CQI is a wide-band CQI.

9. The method of example 1 or 2 wherein range and/or resolution indicator(s) comprises a separate range and/or resolution indicator for each of the two or more sub-bands.

10. The method of example 1 or 2 wherein the range and/or resolution indicator(s) comprise a separate range offset indicator for each of the two or more sub-bands, wherein each range offset indicator indicates a range offset for the respective sub-band relative to offset level values defined in an existing sub-band differential CQI table.

11. The method of example 10 wherein each separate range offset indicator is a 1-bit range offset indicator.

12. The method of example 1 or 2 wherein the range and/or resolution indicator(s) comprise a range and/or resolution indicator that is common to all of two or more sub-bands and a separate range and/or resolution indicator for at least one of the two or more sub-bands.

13. The method of example 1 or 2 wherein the range and/or resolution indicator(s) is a range scaling indicator(s) that indicates a scaling factor(s) to be applied to offset level values defined in an existing sub-band differential CQI table.

14. The method of example 1 or 2 wherein the range and/or resolution indicator(s) is a range and resolution indicator(s) for sub-band CQI.

15. The method of example 14 wherein the range and resolution indicator(s) for sub-band CQI comprises information that indicates a maximum sub-band CQI value and a minimum sub-band CQI value, wherein a resolution for sub-band CQI is given by a number of bits used for sub-band differential CQI.

16. The method of example 14 wherein the range and resolution indicator(s) for sub-band CQI comprises information that indicates a minimum sub-band CQI value and a resolution for sub-band CQI.

17. The method of any of examples 1 to 16 wherein the range and/or resolution indicator(s) comprise one range and/or resolution indicator per transport block.

18. The method of any of examples 1 to 16 wherein the range and/or resolution indicator(s) comprise a common range and/or resolution indicator for two or more transport blocks.

19. The method of example 1 wherein the range and/or resolution indicator(s) comprise, for each sub-band of the two or more sub-bands, a J+K bit indicator of which J bits provide a parameter that serves as a sub-band range and/or resolution indicator and K bits that use the parameter to provide an offset level for the sub-band.

20. The method of example 19 wherein the parameter is an offset scale.

21. The method of example 19 wherein the parameter is an offset shift.

22. The method of any of examples 1 to 21 wherein the range and/or resolution indicator(s) comprise separate indicators for two or more groups of sub-bands.

23. The method of any of the previous examples, further comprising:
providing user data; and
forwarding the user data to a host computer via the transmission to the base station.

### Group B Examples

24. A method performed by a network node, the method comprising:
receiving (706), from a wireless communication device (612), a range and/or resolution indicator(s) for sub-band Channel Quality Indicator, CQI, based on sub-band CQI values for two or more sub-bands, the range and/or resolution indicator(s) comprising: (a) a range indicator for sub-band CQI, (b) a resolution indicator for sub-band CQI, or (c) a range and resolution indicator for sub-band CQI;
receiving (706), from the wireless communication device (612), sub-band CQI indicator values for the sub-band CQI values; and
determining (708) sub-band CQI values for the two or more sub-bands for the wireless communication device (612) based on the sub-band CQI indicator values and the range and/or resolution indicator(s) for sub-band CQI.

25. The method of example 24 further comprising using (710) the determined sub-band CQI values to perform one or more operational tasks (e.g., selection of a MCS for a transmission to or from the wireless communication device (612) based on the determined sub-band CQI values).

26. The method of example 24 or 25 wherein the range and/or resolution indicator(s) for sub-band CQI is/are in accordance with any of examples 2 to 22.

27. The method of any of the previous examples, further comprising:
obtaining user data; and
forwarding the user data to a host computer or a wireless communication device.

### Group C Examples

28. A wireless communication device comprising:
processing circuitry configured to perform any of the steps of any of the Group A examples; and
power supply circuitry configured to supply power to the wireless communication device.

29. A network node comprising:
processing circuitry configured to perform any of the steps of any of the Group B examples; and
power supply circuitry configured to supply power to the network node.

30. A User Equipment, UE, comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A examples;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

31. A communication system including a host computer comprising:
processing circuitry configured to provide user data; and
a communication interface configured to forward the user data to a cellular network for transmission to a User Equipment, UE;
wherein the cellular network comprises a network node having a radio interface and processing circuitry, the network node's processing circuitry configured to perform any of the steps of any of the Group B examples.

32. The communication system of the previous example further including the network node.

33. The communication system of the previous 2 examples, further including the UE, wherein the UE is configured to communicate with the network node.

34. The communication system of the previous 3 examples, wherein:
the processing circuitry of the host computer is configured to execute a host application, thereby providing the user data; and
the UE comprises processing circuitry configured to execute a client application associated with the host application.

35. A method implemented in a communication system including a host computer, a network node, and a User Equipment, UE, the method comprising:
at the host computer, providing user data; and
at the host computer, initiating a transmission carrying the user data to the UE via a cellular network comprising the network node, wherein the network node performs any of the steps of any of the Group B examples.

36. The method of the previous example, further comprising, at the network node, transmitting the user data.

37. The method of the previous 2 examples, wherein the user data is provided at the host computer by executing a host application, the method further comprising, at the UE, executing a client application associated with the host application.

38. A User Equipment, UE, configured to communicate with a network node, the UE comprising a radio interface and processing circuitry configured to perform the method of the previous 3 examples.

39. A communication system including a host computer comprising:
processing circuitry configured to provide user data; and
a communication interface configured to forward user data to a cellular network for transmission to a User Equipment, UE;
wherein the UE comprises a radio interface and processing circuitry, the UE's components configured to perform any of the steps of any of the Group A examples.

40. The communication system of the previous example, wherein the cellular network further includes a network node configured to communicate with the UE.

41. The communication system of the previous 2 examples, wherein:
the processing circuitry of the host computer is configured to execute a host application, thereby providing the user data; and
the UE's processing circuitry is configured to execute a client application associated with the host application.

42. A method implemented in a communication system including a host computer, a network node, and a User Equipment, UE, the method comprising:
at the host computer, providing user data; and
at the host computer, initiating a transmission carrying the user data to the UE via a cellular network comprising the network node, wherein the UE performs any of the steps of any of the Group A examples.

43. The method of the previous example, further comprising at the UE, receiving the user data from the network node.

44. A communication system including a host computer comprising:
communication interface configured to receive user data originating from a transmission from a User Equipment, UE, to a network node;
wherein the UE comprises a radio interface and processing circuitry, the UE's processing circuitry configured to perform any of the steps of any of the Group A examples.

45. The communication system of the previous example, further including the UE.

46. The communication system of the previous 2 examples, further including the network node, wherein the network node comprises a radio interface configured to communicate with the UE and a communication interface configured to forward to the host computer the user data carried by a transmission from the UE to the network node.

47. The communication system of the previous 3 examples, wherein:
the processing circuitry of the host computer is configured to execute a host application; and
the UE's processing circuitry is configured to execute a client application associated with the host application, thereby providing the user data.

48. The communication system of the previous 4 examples, wherein:
the processing circuitry of the host computer is configured to execute a host application, thereby providing request data; and
the UE's processing circuitry is configured to execute a client application associated with the host application, thereby providing the user data in response to the request data.

49. A method implemented in a communication system including a host computer, a network node, and a User Equipment, UE, the method comprising:
at the host computer, receiving user data transmitted to the network node from the UE, wherein the UE performs any of the steps of any of the Group A examples.

50. The method of the previous example, further comprising, at the UE, providing the user data to the network node.

51. The method of the previous 2 examples, further comprising:
at the UE, executing a client application, thereby providing the user data to be transmitted; and
at the host computer, executing a host application associated with the client application.

52. The method of the previous 3 examples, further comprising:
at the UE, executing a client application; and
at the UE, receiving input data to the client application, the input data being provided at the host computer by executing a host application associated with the client application;
wherein the user data to be transmitted is provided by the client application in response to the input data.

53. A communication system including a host computer comprising a communication interface configured to receive user data originating from a transmission from a User Equipment, UE, to a network node, wherein the network node comprises a radio interface and processing circuitry, the network node's processing circuitry configured to perform any of the steps of any of the Group B examples.

54. The communication system of the previous example further including the network node.

55. The communication system of the previous 2 examples, further including the UE, wherein the UE is configured to communicate with the network node.

56. The communication system of the previous 3 examples, wherein:
the processing circuitry of the host computer is configured to execute a host application; and
the UE is configured to execute a client application associated with the host application, thereby providing the user data to be received by the host computer.

57. A method implemented in a communication system including a host computer, a network node, and a User Equipment, UE, the method comprising:
at the host computer, receiving, from the network node, user data originating from a transmission which the network node has received from the UE, wherein the UE performs any of the steps of any of the Group A examples.

58. The method of the previous example, further comprising at the network node, receiving the user data from the UE.

59. The method of the previous 2 examples, further comprising at the network node, initiating a transmission of the received user data to the host computer.

1. A method performed by a wireless communication device, the method comprising:
determining at least one range and/or resolution indicator, RRI, for sub-band Channel Quality Indicator, CQI, based on sub-band CQI values for two or more sub-bands;
determining sub-band differential CQI values for the sub-band CQI values relative to a wide-band CQI value based on the determined RRI; and
transmitting the determined at least one RRI for sub-band CQI and the determined sub-band differential CQI values to a network node.

2. A method performed by a network node, the method comprising:
receiving, from a wireless communication device, at least one range and/or resolution indicator, RRI, for sub-band Channel Quality Indicator, CQI, the RRI being based on sub-band CQI values for two or more sub-bands;
receiving, from the wireless communication device, sub-band differential CQI values; and
determining the sub-band CQI values for the two or more sub-bands for the wireless communication device based on the sub-band differential CQI values and the at least one RRI for sub-band CQI.

3. The method of claim 2, further comprising using the determined sub-band CQI values to perform selection of a modulation and coding scheme, MCS, for a transmission to or from the wireless communication device based on the determined sub-band CQI values.

4. The method of claim 1, wherein the at least one RRI for sub-band CQI comprises a range and/or resolution indicator that is common to all of the two or more sub-bands.

5. The method of claim 1, wherein the at least one RRI is a table-indicator that indicates a sub-band differential CQI table, wherein different values of the table-indicator point to different sub-band differential CQI tables.

6. The method of claim 5, wherein at least two of the different sub-band differential CQI tables map different numbers of sub-band differential CQI values to respective offset levels, or wherein at least two of the different sub-band differential COI tables have different ranges of offset levels.

7. (canceled)

8. The method of claim 1, wherein the at least one RRI is a range indicator that indicates an offset relative to offset levels defined in an existing sub-band differential CQI table, wherein the range indicator is common for all of the two or more sub-bands, and the range indicator, R_{offset}, is determined based on a smallest sub-band COI value, min-SB-CQI, among the sub-band COI values for the sub-bands such that min-SB-CQI≥WB-CQI−1+R_{offset}, where WB-CQI is the wide-band CQI.

9. (canceled)

10. The method of claim 1, wherein the at least one RRI comprises an individual RRI for each of the two or more sub-bands.

11. The method of claim 1, wherein the at least one RRI comprises an individual range indicator for each of the two or more sub-bands, wherein each range indicator indicates an offset for the respective sub-band relative to offset levels defined in an existing sub-band differential CQI table.

12. The method of claim 1, wherein the at least one RRI comprises a range and/or resolution indicator that is common to all of the two or more sub-bands and a separate range and/or resolution indicator for at least one of the two or more sub-bands.

13. (canceled)

14. The method of claim 1, wherein the at least one RRI is a range and resolution indicator for sub-band CQI, and the range and resolution indicator for sub-band CQI comprises information that indicates a maximum sub-band CQI value and a minimum sub-band CQI value as the range for the sub-band CQI, and wherein a resolution for sub-band CQI is given by a number of bits used for sub-band differential CQI.

15. The method of claim 1, wherein the at least one RRI is a range and resolution indicator for sub-band CQI, and the range and resolution indicator for sub-band CQI comprises information that indicates a minimum sub-band CQI value and a resolution for sub-band CQI.

16. The method of claim 1, wherein the at least one RRI comprises one range and/or resolution indicator per transport block for which the sub-band differential CQI values are reported.

17. The method of claim 1, wherein the at least one RRI comprises a common range and/or resolution indicator for two or more transport blocks for which the sub-band differential CQI values are reported.

18. The method of claim 1, wherein the at least one RRI comprises, for each sub-band of the two or more sub-bands, a J+K bit indicator of which J bits provide a parameter that serves as a sub-band range and/or resolution indicator and K bits provide an offset level for the sub-band as a function of the parameter provided by the J bits.

19. The method of claim 18, wherein the parameter is an offset scale, wherein the offset level scales in proportion with the offset scale.

20. The method of claim 18, wherein the parameter is an offset shift, wherein the offset level is shifted by the offset shift.

21. The method of claim 1, wherein the at least one RRI comprises separate indicators for two or more groups of sub-bands that are divided from the two or more sub-bands.

22. A wireless communication device configured to:
determine at least one range and/or resolution indicator, RRI, for sub-band Channel Quality Indicator, CQI, based on sub-band CQI values for two or more sub-bands;
determine sub-band differential CQI values for the sub-band CQI values relative to a wide-band CQI value based on the determined RRI; and
transmit the determined at least one RRI for sub-band CQI and the determined sub-band differential CQI values to a network node.

23. (canceled)

24. A network node configured to:
receive from a wireless communication device, at least one range and/or resolution indicator, RRI, for sub-band Channel Quality Indicator, CQI, determined based on sub-band CQI values for two or more sub-bands;
receive, from the wireless communication device, sub-band differential CQI values; and
determine the sub-band CQI values for the two or more sub-bands for the wireless communication device based on the sub-band differential CQI values and the at least one RRI for sub-band CQI.

25. (canceled)
